(19) United States
(12) Patent Application Publication
(10) Pub. No.: US 2011/0164010 A1
(43) Pub. Date: Jul. 7, 2011

(54) Display apparatus, light detection method and electronic apparatus

(75) Inventors: Tetsuro Yamamoto, Kanagawa (JP); Katsuhide Uchino, Kanagawa (JP)

(73) Assignee: Sony Corporation, Tokyo (JP)

(21) Appl. No.: 12/926,999

(22) Filed: Dec. 22, 2010

(30) Foreign Application Priority Data
Jan. 7, 2010 (JP) 2010-001878

(51) Int. Cl. G09G 3/30; G09G 5/10

(52) U.S. Cl. 345/207; 345/77

(57) ABSTRACT

Disclosed herein is a display apparatus including a plurality of pixel circuits, a displaying driving section, and a light amount information detection section. The pixel circuits are disposed in a matrix at positions at which a signal line and a plurality of scanning lines cross with each other. The displaying driving section applies a signal value to each pixel circuit and drives the scanning lines to cause the pixel circuit to emit light with a luminance according to the signal value to carry out image display. The light amount information detection section detects light amount information. Each pixel circuit includes a light emitting element, a driving transistor, a sampling transistor, and a switching transistor. Each pixel circuit can execute light detection operation of varying the gate potential of the driving transistor in response to a received light amount and outputting the source potential of the driving transistor.

### BACKGROUND OF THE INVENTION

1. Field of the Invention

The present invention relates to a display apparatus wherein a self-luminous device such as, for example, an organic electroluminescence device (organic EL device) is used in a pixel circuit and a light detection method for a light detection section provided in the pixel circuit and an electronic apparatus.

2. Description of the Related Art

In a display apparatus of the active matrix type wherein an organic electroluminescence (EL: Electroluminescence) light emitting element is used as a pixel, current flowing to a night emitting element in each pixel circuit is controlled by an active device, generally a thin film transistor (TFT) provided in each pixel circuit. Since an organic EL device is a current light emitting element, a gradation of color development is obtained by controlling the amount of current flowing to the EL device.

In particular, in a pixel circuit which includes an organic EL device, current corresponding to an applied signal value voltage is supplied to the organic EL device to carry out light emission of a gradation in accordance with the signal value.

In a display apparatus which uses a self-luminous device such as a display apparatus which uses such an organic EL device as described above, it is important to cancel the dispersion in light emission luminance among pixels to eliminate non-uniformity which appears on a screen.

While the dispersion in light emission luminance among pixels appears also in an initial state upon panel fabrication, the dispersion is caused by time-dependent variation.

A light emission efficiency of an organic EL device is degraded by passage of time. In particular, even if the same current flows, the emitted light luminance degrades together with passage of time.

As a result, a screen burn that, if a white WINDOW pattern is displayed on the black background and then the white is displayed on the full screen as shown, for example, in FIG. 31A, then the luminance at the portion at which the WINDOW pattern is displayed decreases.

A countermeasure against such a situation as described above is disclosed in JP-T-2007-501953 or JP-T-2008-518263 (referred to as Patent Document 1 and 2, respectively, hereinafter). In particular, Patent Document 1 discloses an apparatus wherein a light sensor is disposed in each pixel circuit and a detection value of the light sensor is fed back to the system to correct the emitted light luminance. Patent Document 2 discloses an apparatus wherein a detection value is fed back from a light sensor to a system to carry out correction of the emitted light luminance.

### SUMMARY OF THE INVENTION

The present invention is applied to a display apparatus which has a function of detecting light in a pixel circuit. The present invention implements a display apparatus wherein a signal value to be applied to a pixel circuit is corrected, for example, in response to detected light amount information to prevent appearance of a screen burn and so forth. Further, the present invention implements a pixel circuit for the display apparatus which can be configured from a comparatively small number of elements, control lines and so forth.

According to an embodiment of the present invention, there are provided a display apparatus and an electronic apparatus comprising a plurality of pixel circuits disposed in a matrix at positions at which a signal line and a plurality of scanning lines cross with each other, a displaying driving section adapted to apply a signal value to each of the pixel circuits through the signal line and drive the scanning lines to cause the pixel circuit to carry out light emission with a luminance in accordance with the signal value to carry out image display, and a light amount information detection section adapted to detect light amount information from an output of each of the pixel circuits to a light detection line disposed for the pixel circuit, each of the pixel circuits including a light emitting element, a driving transistor for carrying out application of current to the light emitting element in response to a signal value voltage inputted thereto, a sampling transistor for inputting, when the sampling transistor is switched on, the signal value from the signal line to the gate of the driving transistor, and a switching transistor connected between an end of the driving transistor and the light detection line, each of the pixel circuits being capable of executing light detection operation of varying the gate potential of the driving transistor in response to a received light amount and outputting the source potential of the driving transistor in accordance with the potential variation to the light detection line through the switching transistor.

According to another embodiment of the present invention, there is provided light detection method for a display apparatus which includes a plurality of pixel circuits disposed in a matrix at positions at which a signal line and a plurality of scanning lines cross with each other, a displaying driving section adapted to apply a signal value to each of the pixel circuits through the signal line and drive the scanning lines to cause the pixel circuit to carry out light emission with a luminance in accordance with the signal value to carry out image display, and a light amount information detection section adapted to detect light amount information from an output of each of the pixel circuits to a light detection line disposed for the pixel circuit, each of the pixel circuits including a light emitting element, a driving transistor for carrying out application of current to the light emitting element in response to a signal value voltage inputted thereto, a sampling transistor for inputting, when the sampling transistor is switched on, the signal value from the signal line to the gate of the driving transistor, and a switching transistor connected between an end of the driving transistor and the light detection line, the light detection method including the step of:

varying, by means of the pixel circuit, the gate potential of the driving transistor in response to the received light amount and outputting the source potential of the driving transistor in response to the potential variation to the light detection line through the switching transistor, and then detecting, by means of the light amount information detection section, light amount information by voltage detection of the light detection line.

According to further embodiment of the present invention, there is provided a display apparatus, including:

a plurality of pixel circuits disposed in a matrix;

a signal line; and

a light detection line;

each of the pixel circuits including
a light emitting element,
a driving transistor for carrying out current application to the light emitting element,
a sampling transistor for inputting a signal value from the signal line to the gate of the driving transistor, and
a switching transistor connected between an end of the driving transistor and the light detection' line;

the gate potential of the driving transistor being varied in response to a received light amount to output a potential at the one end of the driving transistor to the light detection line through the switching transistor.

In the display apparatus and the electronic apparatus as well as the light detection method for a display apparatus, each pixel circuit has a light sensor function. For example, the sampling transistor in each pixel circuit functions as a light sensor when it is in an off state. In particular, the potential of the gate of the driving transistor is varied in response to the amount of received light by the sampling transistor. The variation of the gate potential of the driving transistor is outputted as a variation of the source potential of the driving transistor to the light detection line through the switching transistor. Therefore, by carrying out voltage detection of the light detection line, the light amount information detection section can detect the amount of light received by the pixel circuit.

By the configuration described, each pixel circuit can detect the amount of light emitted from the pixel circuit itself, the amount of light emitted from a neighboring pixel circuit or circuits, and the amount of external light.

The information of the detected light amount may be used as information of deterioration of the luminance of light emitted from the pixel circuit or as external input information.

With the display apparatus and the electronic apparatus as well as the light detection method for a display apparatus, a light detection section is not provided independently of each pixel circuit, but the configuration of the pixel circuit can be utilized to carry out light detection without giving rise to increase of the number of elements or the number of control lines.

For example, the sampling transistor is used as a light sensor to vary the potential of the gate of the driving transistor in response to the detected light amount, and the driving transistor is connected at the source thereof to the light detection line through the switching transistor. By the configuration, the number of transistors and the number of control lines for the transistors can be reduced in comparison with those of an alternative configuration which utilizes a light detection circuit for exclusive use.

As a result, enhancement of the yield can be implemented, and it is possible to take a countermeasure against a failure in picture quality caused by deterioration of the efficiency of the light emitting element such as a screen burn.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a block diagram showing a display apparatus according to a first embodiment of the present invention;

FIG. 2 is a circuit diagram showing a configuration example 1 which has been taken into consideration in the course to the present invention;

FIG. 3 is a waveform diagram illustrating operation of the circuit of FIG. 2;

FIG. 4 is a circuit diagram showing a configuration example 2 which has been taken into consideration in the course to the present invention;

FIG. 5 is a waveform diagram illustrating operation of the circuit of FIG. 4;

FIGS. 6 to 9 are equivalent circuit diagrams illustrating operation of the circuit of FIG. 4;

FIG. 10 is a circuit diagram showing a pixel circuit according to a first embodiment of the present invention;

FIG. 11 is a circuit diagram showing neighboring pixel circuits in the first embodiment;

FIG. 12 is a waveform diagram showing control waveforms in a light detection operation example A in the first embodiment;

FIG. 13 is a waveform diagram showing operation waveforms in the light detection operation example A in the first embodiment;

FIG. 14 is a waveform diagram showing control waveforms in a light detection operation example B in the first embodiment;

FIG. 15 is a waveform diagram showing operation waveforms in the light detection operation example B in the first embodiment;

FIG. 16 is a waveform diagram showing control waveforms in a light detection operation example C in the first embodiment;

FIG. 17 is a waveform diagram showing operation waveforms in the light detection operation example C in the first embodiment;

FIGS. 18A and 18B are diagrammatic views illustrating light detection operation period according to an embodiment of the present invention;

FIGS. 19A and 19B are diagrammatic views illustrating light detection operation period according to an embodiment of the present invention;

FIG. 20 is a block diagram showing a display apparatus according to a second embodiment of the present invention;

FIG. 21 is a circuit diagram showing a pixel circuit according to the second embodiment of the present invention;

FIG. 22 is a waveform diagram showing an ordinary light emitting operation of the pixel circuit of FIG. 21;

FIG. 23 is a circuit diagram showing neighboring pixel circuits in the second embodiment;

FIG. 24 is a waveform diagram showing control waveforms in a light detection operation example in the second embodiment;

FIG. 25 is a waveform diagram showing operation waveforms in the light detection operation example in the second embodiment;

FIGS. 26A and 26B are circuit diagrams showing a modification to the pixel circuit shown in FIG. 21;

FIG. 27 is a waveform diagram showing control waveforms of the modified pixel circuit of FIGS. 26A and 26B;

FIGS. 28A and 28B are schematic views illustrating examples of an application of a pixel circuit according to a third embodiment of the present invention;

FIG. 29 is a circuit diagram showing a pixel circuit according to a third embodiment of the present invention;

FIG. 30 is a waveform diagram showing operation waveforms in the light detection operation example according to the third embodiment of the present invention; and

FIGS. 31A and 31B are schematic views illustrating correction against a screen burn.

### DETAILED DESCRIPTION OF THE PREFERRED EMBODIMENTS

In the following, embodiments of the present invention are described in the following order.

### <1. Configuration of the Display Apparatus>

<2. Taken into Consideration in the Course to the Present Invention: Configuration Examples 1, 2>

### <3. First Embodiment>

[3-1. Circuit Configuration]

[3-2. Light Detection Operation Example A]

[3-3. Light Detection Operation Example B]

[3-4. Light Detection Operation Example C]

[3-5. Light Detection Operation Period]

### <4. Second Embodiment>

[4-1. Circuit Configuration]

[4-2. Light Detection Operation]

[4-3. Modification of Second Embodiment]

### <5. Third Embodiment>

### <6. Modification>

### 1. Configuration of the Display Apparatus

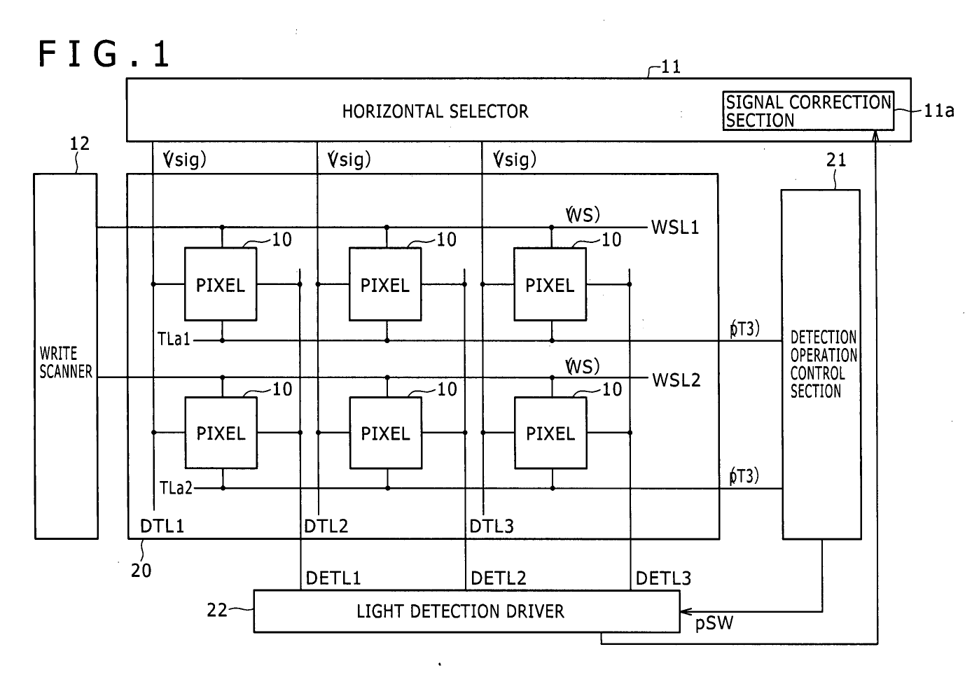

A configuration of an organic EL display apparatus according to a first embodiment of the present invention is shown in FIG. 1. The organic EL display apparatus is incorporated as a display device in various electronic apparatus. In particular, the organic EL display apparatus is incorporated in various electronic apparatus such as, for example, a television receiver, a monitor apparatus, a recording and reproduction apparatus, a communication apparatus, a computer apparatus, an audio apparatus, a video apparatus, a game machine and a home electronics apparatus.

The organic EL display apparatus includes a plurality of pixel circuits 10 each including an organic EL device as a light emitting element for carrying out light emission driving in accordance with an active matrix method.

Referring to FIG. 1, the organic EL display apparatus includes a pixel array 20 wherein a great number of pixel circuits 10 are arranged in a matrix in a row direction and a column direction. It is to be noted that each of the pixel circuits 10 functions as one of light emitting pixels of R (red), G (green) and B (blue), and a color display apparatus is configured by arranging the pixel circuits 10 of the individual colors in accordance with a predetermined rule.

As components for driving the pixel circuits 10 to emit light, a horizontal selector 11 and a write scanner 12 are provided.

Signal lines DTL, particularly DTL1, DTL2, . . . , which are selected by the horizontal selector 11 for supplying a voltage in accordance with a signal value, that is, a gradation value, of a luminance signal as display data to the pixel circuits 10 are arranged in the column direction on the pixel array 20. The number of signal lines DTL1, DTL2, . . . is equal to the number of columns of the pixel circuits 10 disposed in a matrix in the pixel array 20.

Further, on the pixel array 20, writing control lines WSL, that is, WSL1, WSL2, . . . , are arranged in the row direction. The number of writing control lines WSL is equal to the number of the pixel circuits 10 disposed in a matrix in the row direction on the pixel array 20.

The writing control lines WSL, that is, WSL1, WSL2, . . . , are driven by the write scanner 12. The write scanner 12 successively supplies a scanning pulse WS to the writing control lines WSL1, WSL2, . . . disposed in rows to line-sequentially scan the pixel circuits 10 in a unit of a row.

The horizontal selector 11 supplies a signal value potential Vsig as an input signal to the pixel circuits 10 to the signal lines DTL1, DTL2, . . . disposed in the column direction in a timed relationship with the line-sequential scanning by the write scanner 12.

Although details are hereinafter described, each pixel circuit 10 has a light sensor function of detecting an emitted light amount of the pixel itself and a neighboring pixel. Then, each pixel circuit 10 outputs, upon light detection operation, a signal in response to the light detection.

Further, a detection operation control section 21 for controlling light detecting operation of the pixel circuit 10 is provided. Control lines TLa (TLa1, TLa2 . . . ) extend from the detection operation control section to the light detection sections 30 in a row direction.

The control lines TLa function to supply a control pulse pT3 for on/off control of a switching transistor T3 in the pixel circuit 10 to be described later.

Further, light detection lines DETL, that is, DETL1, DETL2, . . . , are disposed, for example, in a column direction for each pixel circuit 10. The light detection lines DETL are used as lines for outputting a voltage as information in response to the light detection by the pixel circuit 10.

The light detection lines DETL, that is, DETL1, DETL2, . . . , are connected to a light detection driver 22. The light detection driver 22 carries out voltage detection regarding the light detection lines DETL to detect light amount information.

The light detection driver 22 applies light amount detection information regarding the pixel circuits 10 to a signal value correction section 11a in the horizontal selector 11.

The signal value correction section 11a decides a degree of degradation of the light emission efficiency of the organic EL device in the pixel circuits 10 based on the light amount detection information and carries out a correction process of the signal value Vsig to be applied to the pixel circuits 10 in accordance with a result of the decision.

The light emission efficiency of an organic EL device degrades as time passes. In particular, even if the same current is supplied, the light emission luminance decreases as time passes. Therefore, in the display apparatus according to the present embodiment, the emitted light amount of each pixel circuit 10 is detected and degradation of the light emission luminance is decided based on a result of the detection. Then, the signal value Vsig itself is corrected in response to the degree of degradation. For example, where the signal value Vsig as a certain voltage value V1 is to be applied, correction is carried out such that a correction value a determined based on the degree of degradation of the light emission luminance is set and the signal value Vsig as the voltage value V1+α is applied.

The degradation of the light emission luminance of each pixel circuit 10 detected in such a manner as just described is compensated for by feeding back the same to the signal value Vsig to decrease a screen burn.

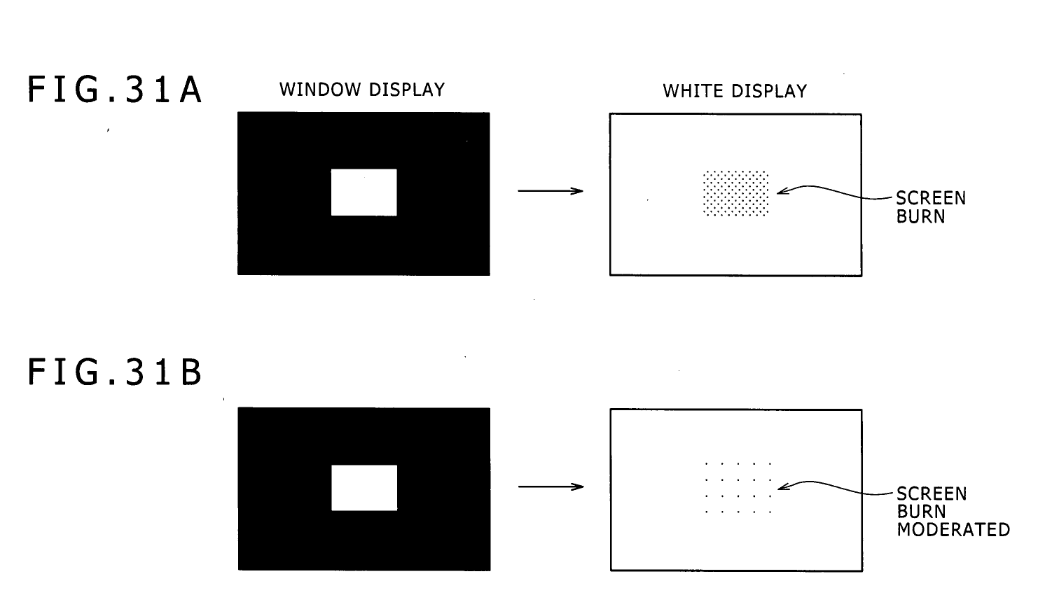

In particular, for example, in a situation wherein a screen burn occurs as seen in FIG. 31A, the screen burn is decreased as seen in FIG. 31B.

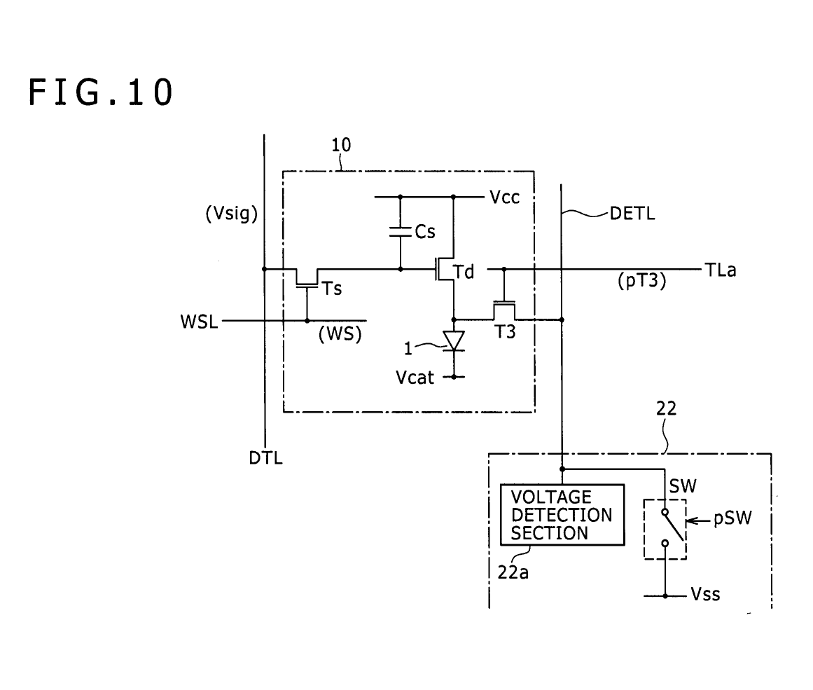

It is to be noted that, though not shown in FIG. 1, potential lines for supply a power supply voltage Vcc and a cathode potential Vcat and the like as a required fixed potential are connected to the pixel circuits 10 (shown in FIG. 10).

### 2. Taken into Consideration in the Course to the Present Invention

### Configuration Examples 1, 2

Here, before the circuit configuration and operation of the embodiment of the present invention are described, configuration examples 1 and 2 which have been taken into consideration in the course to the present invention are described to facilitate understandings of the present embodiment.

It is to be noted that the applicant recognizes that the configuration examples 1 and 2 are not publicly known inventions.

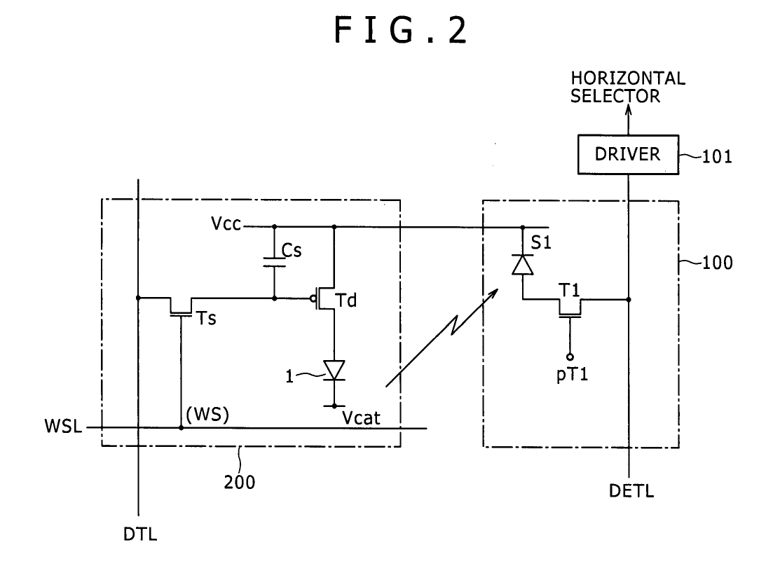

First, as the configuration example 1, FIG. 2 shows a pixel circuit 200 and a light detection section 100 contrived for reduction of a screen burn.

The pixel circuit 200 includes a driving transistor Td composed of a p-channel TFT, a sampling transistor Ts composed of an n-channel TFT, a holding capacitor Cs and an organic EL element 1. It is to be noted that, although the circuit configuration of this pixel circuit 200 is different from that of the pixel circuit 10 of the embodiment described above, a plurality of such pixel circuits are disposed on the display apparatus similarly as in the display apparatus of FIG. 1. In FIG. 2, one pixel circuit 200 disposed at a crossing point between a signal line DTL and a writing control line WSL and one write detection section 100 provided corresponding to the pixel circuit 200 are shown.

The signal line DTL is connected to the drain of the sampling transistor Ts, and the writing control line WSL is connected to the gate of the sampling transistor Ts.

The driving transistor Td and the organic EL element 1 are connected in series between a power supply voltage Vcc and a cathode potential Vcat.

The sampling transistor Ts and the holding capacitor Cs are connected to the gate of the driving transistor Td.

In the present pixel circuit 200, when the horizontal selector 11 applies a signal value corresponding to a luminance signal to the signal line DTL, if a write scanner 12 places the scanning pulse WS of the writing control line WSL to the H level, then the sampling transistor Ts is rendered conducting and the signal value is written into the holding capacitor Cs. The signal value potential written in the holding capacitor Cs becomes the gate potential of the driving transistor Td.

If the write scanner 12 places the scanning pulse WS of the writing control line WSL into the L level, then although the signal line DTL and the driving transistor Td are electrically disconnected from each other, the gate potential of the driving transistor Td is held stably by the holding capacitor Cs.

Then, driving current Ids flows to the driving transistor Td and the organic EL element 1 so as to be directed from the power supply voltage Vcc toward the cathode potential Vcat.

At this time, the driving current Ids exhibits a value corresponding to the gate-source voltage Vgs of the driving transistor Td, and the organic EL element 1 emits light with a luminance corresponding to the current value.

In short, in the pixel circuit 200, the signal value potential is written from the signal line DTL into the holding capacitor Cs to vary the gate application voltage of the driving transistor Td thereby to control the value of current to flow to the organic EL element 1 to obtain a gradation of color development.

Since the driving transistor Td in the form of a p-channel TFT is designed such that it is connected at the source thereof to the power supply voltage Vcc so that the driving transistor Td normally operates within a saturation region thereof, the driving transistor Td serves as a source of constant current which has a value given by the following expression (1):

Ids=(1/2)·μ·(W/L)·Cox·(Vgs−Vth)² (1)

where Ids is current flowing between the drain and the source of the transistor which operates in its saturation region, μ the mobility, W the channel width, L the channel length, Cox the gate capacitance, and Vth the threshold voltage of the driving transistor Td.

As apparently recognized from the expression (1) above, within the saturation region, the drain current Ids of the driving transistor Td is controlled by the gate-source voltage Vgs. Since the gate-source voltage Vgs of the driving transistor Td is kept fixed, the driving transistor Td operates as a constant current source and can cause the organic EL element 1 to emit light with a fixed luminance.

Generally, the current-voltage characteristic of the organic EL element 1 degrades as time passes. Thus, in the pixel circuit 200, together with a time-dependent variation of the organic EL element 1, the drain voltage of the driving transistor Td varies. However, since the gate-source voltage Vgs of the driving transistor Td is fixed in the pixel circuit 200, a fixed amount of current flows to the organic EL element 1 and the emitted light luminance does not vary. In short, stabilized gradation control can be anticipated.

However, as time passes, not only the driving voltage but also the light emission efficiency of the organic EL element 1 degrades. In other words, even if the same current is supplied to the organic EL element 1, the emitted light luminance of the organic EL element 1 drops together with time. As a result, such a screen burn as described hereinabove with reference to FIG. 31A appears.

In order to compensate for a drop of the light emission efficiency of the organic EL element 1 of the pixel circuit 200, the light detection section 100 is provided which includes a light detection element or light sensor S1 and a switching transistor T1 interposed between a power supply voltage Vcc and a fixed light detection line DETL.

In this instance, the light sensor S1, for example, in the form of a photodiode supplies leak current corresponding to the amount of emitted light from the organic EL element 1.

Generally, when a diode detects light, current thereof increases. Further, the increasing amount of current varies depending upon the amount of light incident to the diode. In particular, if the light amount is great, then the increasing amount of current is great, and if the light amount is small, then the increasing amount of current is small.

The current flowing through the light sensor S1 flows to the light detection line DETL if the switching transistor T1 is rendered conducting.

An external driver 101 connected to the light detection line DETL detects the amount of current supplied from the light sensor S1 to the light detection line DETL.

The current value detected by the external driver 101 is converted into a detection information signal and supplied to a horizontal selector 11. The horizontal selector 11 decides from the detection information signal whether or not the detection current value corresponds to the signal value Vsig provided to the pixel circuit 200. If the luminance of the emitted light of the organic EL element 1 indicates a degraded level, then the detection current amount indicates a reduced level. In this instance, the signal value Vsig is corrected.

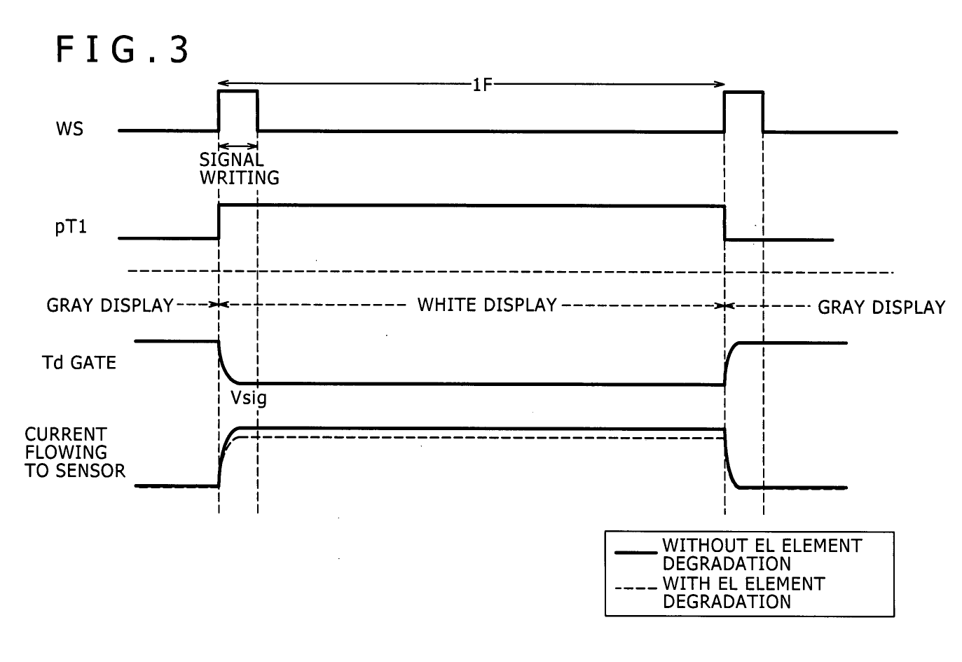

A light detection operation waveform is illustrated in FIG. 3. Here, the period within which the light detection section 100 outputs detection current to the external driver 101 is determined as one frame.

Within a signal writing period illustrated in FIG. 3, the sampling transistor Ts in the pixel circuit 200 exhibits an on state with a scanning pulse WS, and the signal value Vsig applied to a signal line DTL from the horizontal selector 11 is inputted to the pixel circuit 10. The signal value Vsig is inputted to the gate of the driving transistor Td and is retained into the holding capacitor Cs. Therefore, the driving transistor Td supplies current corresponding to the gate-source voltage thereof to the organic EL element 1 so that the organic EL element 1 emits light. For example, if the signal value Vsig is supplied for a white display within a current frame, then the organic EL element 1 emits light of the white level within the current frame.

Within the frame within which light of the white level is emitted, the switching transistor T1 in the light detection section 100 is rendered conducting with a control pulse pT1. Therefore, the variation of current of the light sensor S1 which receives the light of the organic EL element 1 is reflected on the light detection line DETL.

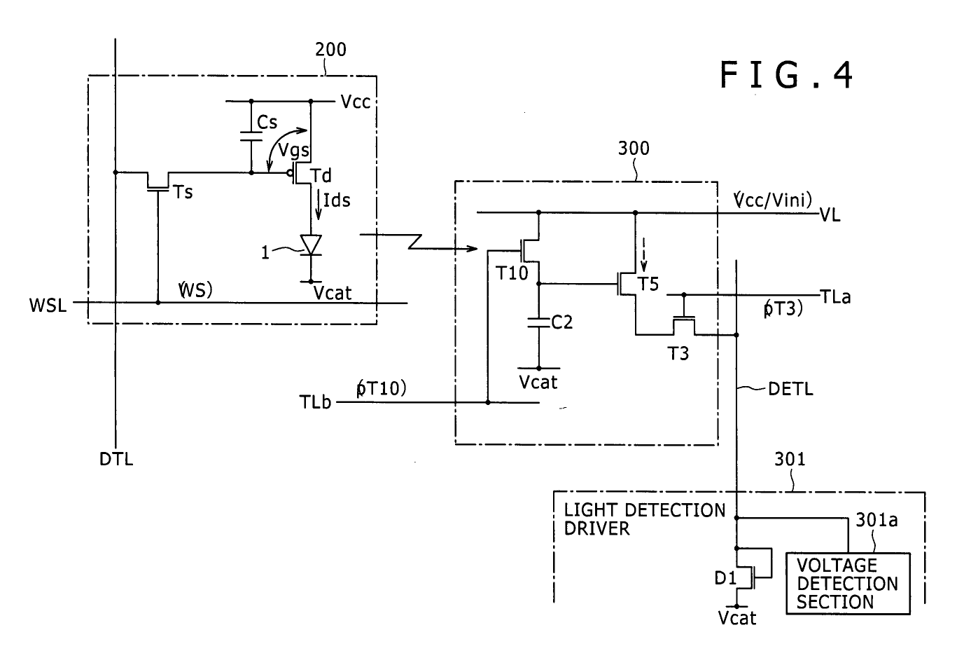

For example, if the amount of current flowing through the light sensor S1 thereupon is equal to the amount of light which should originally be emitted and is such as indicated by a solid line in FIG. 4, then if the emitted light amount is reduced by deterioration of the organic EL element 1, then it is such as indicated by a broken line in FIG. 3.

Since a variation of current corresponding to degradation of the luminance of emitted light appears on the light detection line DETL, the external driver 101 can detect the current amount and obtain information of the degree of degradation. Then, the information is fed back to the horizontal selector 11 to correct the signal value Vsig to carry out compensation for the luminance degradation. Accordingly, a screen burn can be decreased.

However, such a light detection system as described above gives rise to the following disadvantage.

In particular, the light sensor S1 receives emitted light of the organic EL element 1 and increases the current thereof. For a diode as the light sensor S1, preferably an off region thereof in which a great current variation is exhibited, that is, an applied voltage of a negative value proximate to zero, is used. This is because the current variation can be detected comparatively precisely.

However, even if the current value at this time indicates an increase, since it is very low with respect to the on current, if it is intended to detect the luminance variation with a high degree of accuracy, then a long period of time may be required for charging the parasitic capacitance of the light detection line DETL. For example, it is difficult to detect a current variation with a high degree of accuracy in one frame.

As a countermeasure, it is a possible idea to increase the size of the light sensor S1 to increase the amount of current. However, as the size increases, the ratio of the area which the light detection section 100 occupies in a pixel array 20 increases.

Therefore, such a light detection section 300 as a configuration example 2 shown in FIG. 4 has been contrived.

The light detection section 300 shown in FIG. 4 includes a sensor serving transistor T10, capacitor C2, detection signal outputting transistor T5 in the form of an n-channel TFT, and a switching transistor T3.

The sensor serving transistor T10 is connected between a power supply line VL and the gate of the detection signal outputting transistor T5.

The sensor serving transistor T10 is changed over between an on state and an off state so as to function as a switching element and besides functions as a light sensor in the off state thereof.

A TFT has a structure wherein it is formed by disposing a gate metal, a source metal and so forth on a channel layer. The sensor serving transistor T10 is formed so as to have a structure wherein, for example, a metal layer which forms the source and the drain does not comparatively intercept light to the channel layer above the channel layer. In other words, the TFT should be formed so that external light may be admitted into the channel layer.

The sensor serving transistor T10 is disposed so as to detect light emitted from the organic EL element 1. Then, in the off state of the sensor serving transistor T10, leak current thereof increases or decreases in response to the emitted light amount. In particular, if the emitted light amount of the organic EL element 1 is great, then the increasing amount of the leak current is great, but if the emitted light amount is small, then the increasing amount of the leak current is small.

The sensor serving transistor T10 is connected at the gate thereof to a control line TLb. Accordingly, the sensor serving transistor T10 is turned on/off with a control pulse pT10. When the sensor serving transistor T10 is turned on, the potential of the power supply line VL is inputted to the gate of the detection signal outputting transistor T5.

To the power supply line VL, a pulse voltage having two values including a power supply voltage Vcc and a reference voltage Vini is provided.

The capacitor C2 is connected between the cathode potential Vcat and the gate of the detection signal outputting transistor T5. The capacitor C2 is provided to retain the gate voltage of the detection signal outputting transistor T5.

The detection signal outputting transistor T5 is connected at the drain thereof to the power supply line VL. The detection signal outputting transistor T5 is connected at the source thereof to the switching transistor T3.

The switching transistor T3 is connected between the source of the detection signal outputting transistor T5 and the light detection line DETL. The switching transistor T3 is connected at the gate thereof to a control line TLa and accordingly is turned on/off with the control pulse pT3. When the switching transistor T3 is turned on, current flowing to the detection signal outputting transistor T5 is outputted to the light detection line DETL.

A light detection driver 301 includes a voltage detection section 301a for detecting the potential of each of the light detection lines DETL. The voltage detection section 301a detects a detection signal voltage outputted from the light detection section 300.

It is to be noted that the diode D1, for example, in the form of a transistor of a diode connection is connected to the light detection line DETL so as to provide a current path to a fixed value, for example, to the cathode potential Vcat.

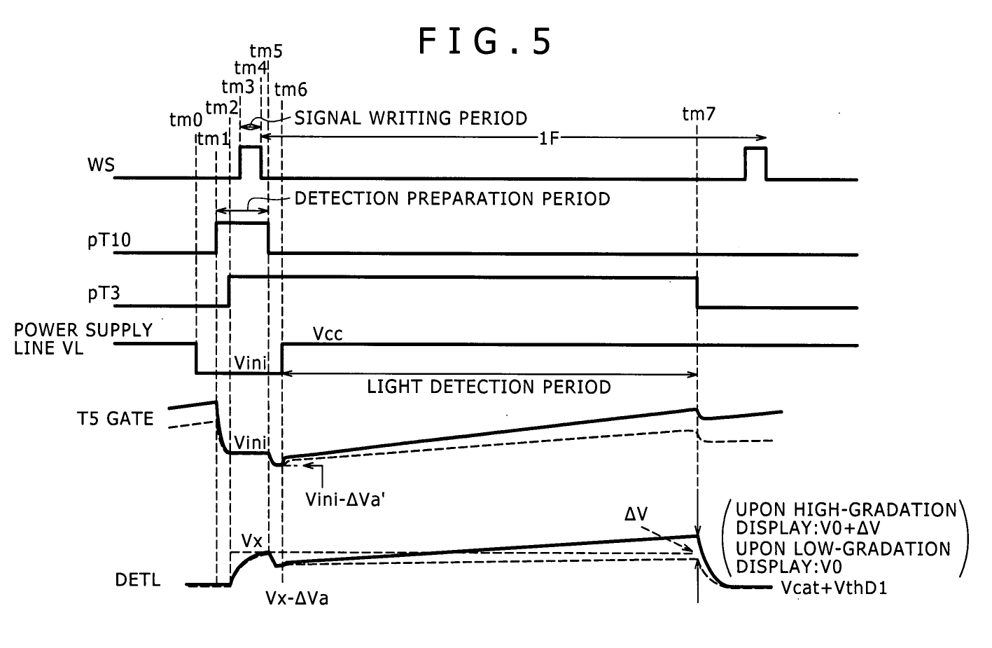

The light detection operation by the light detection section 300 is described with reference to FIGS. 5 to 9.

FIG. 5 shows waveforms regarding the operation of the light detection section 300. In particular, a scanning pulse WS to be applied to the sampling transistor Ts in the pixel circuit 200 is shown here. Also, FIG. 5 further illustrates control pulses pT10, pT3, and a power supply pulse of the power supply line VL to be applied to the control lines TLb and TLa. FIG. 5 further illustrates a gate voltage of the detection signal outputting transistor T5 and a voltage appearing on the light detection line DETL.

It is assumed that one light detection section 300 carries out light amount detection regarding a corresponding one of the pixel circuits 200 within a period of one frame.

First, within a period from time tm0 to time tm6 including a detection preparation period, the power supply line VL is set to the reference voltage Vini. Further, within the period from time tm1 to time tm5, the control pulse pT10 is set to the H level to place the sensor serving transistor T10 into an on state to carry out detection preparations.

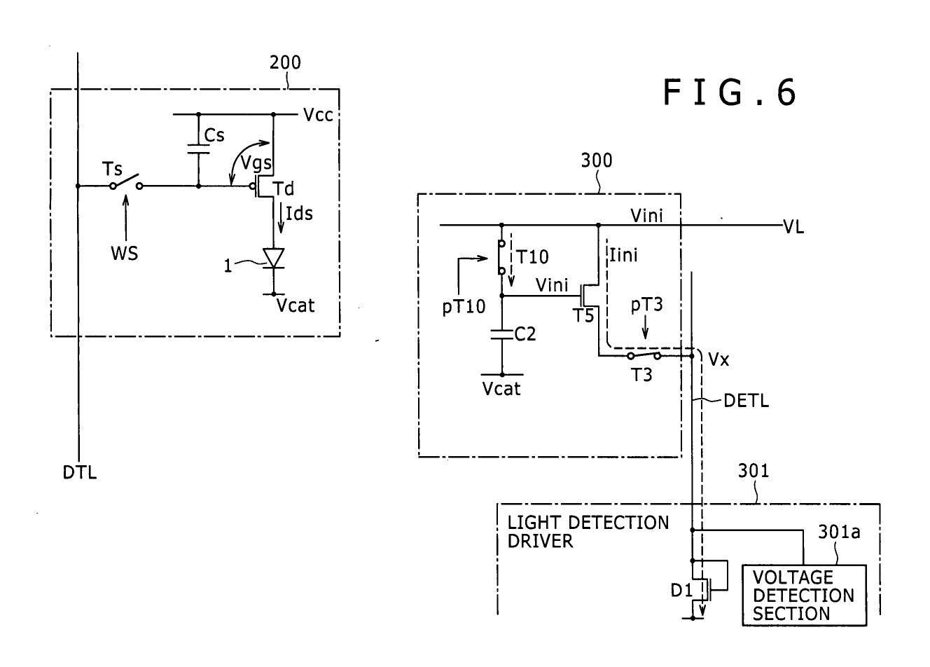

A state at this time is illustrated in FIG. 6. When the sensor serving transistor T10 is placed into an on state at time tm1 at which the power supply line VL has the reference voltage Vini, the reference voltage Vini is inputted to the gate of the detection signal outputting transistor T5. Further, when the switching transistor T3 is placed into an on state by the control pulse pT3 time tm2, the source of the detection signal outputting transistor T5 is connected to the light detection line DETL.

Here, the reference voltage Vini is a voltage with which the detection signal outputting transistor T5 is placed into an on state. Therefore, current Iini flows as seen in FIG. 6, and the light detection line DETL exhibits a certain potential Vx. Since such operations as described above carried out within the detection preparation period, the gate potential of the detection signal outputting transistor T5 is equal to the reference voltage Vini and the potential of the light detection line DETL is equal to the potential Vx.

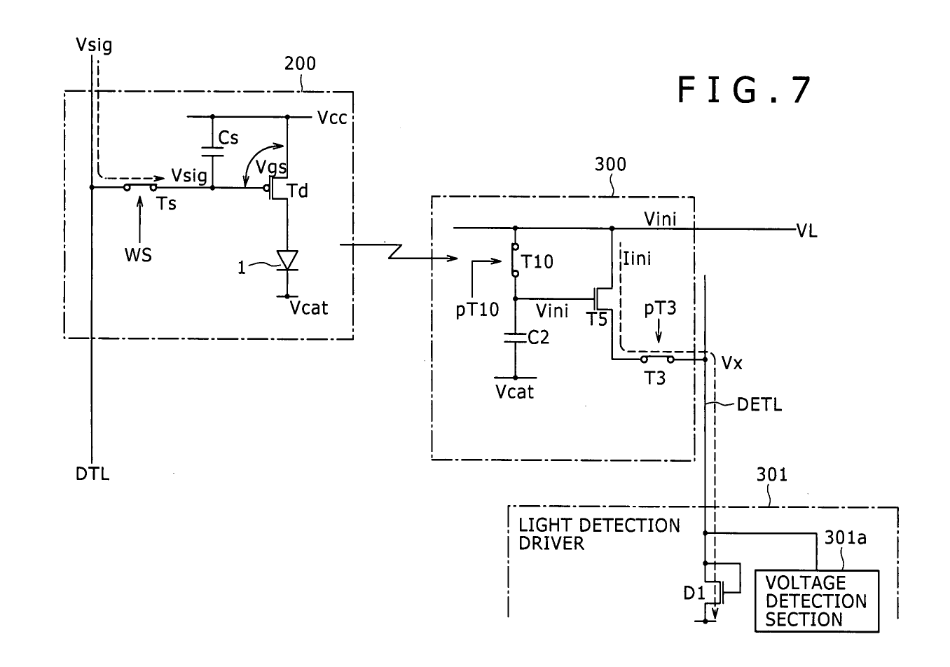

Within the period from time tm3 to time tm4 of FIG. 5, writing of the signal value Vsig into the pixel circuits 10 is carried out for a display for a one-frame period. In particular, within the signal wiring period of FIG. 5, the scanning pulse WS is set to the H level to render the sampling transistor Ts conducting. At this time, the signal value Vsig, for example, of the white display gradation is applied to the signal line DTL. Consequently, in the pixel circuits 200, the organic EL element 1 emits light in accordance with the signal value Vsig. A state in this instance is illustrated in FIG. 7.

At this time, since the sensor serving transistor T10 is on, the gate voltage of the detection signal outputting transistor T5 remains equal to the reference potential Vini.

After the signal writing ends, the sampling transistor Ts in the pixel circuits 200 is turned off at time tm4.

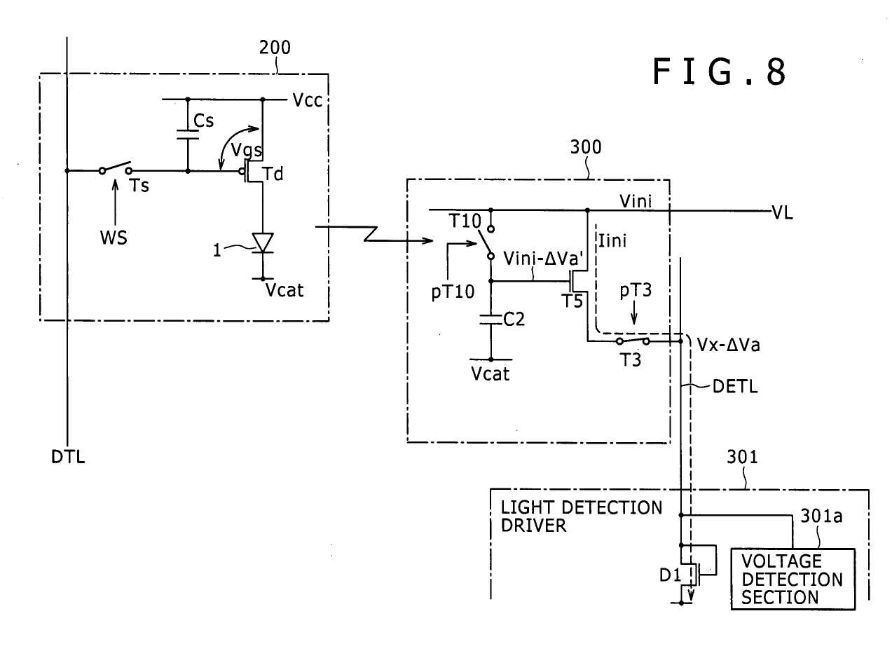

Meanwhile, in the light detection section 30, the control pulse pT10 is placed into the L level at time tm5 to turn off the sensor serving transistor T10. This state is illustrated in FIG. 8.

Where the sensor serving transistor T10 is turned off, a coupling amount ΔVa′ corresponding to a capacitance ratio between the capacitor C2 and the parasitic capacitance of the sensor serving transistor T10 is inputted to the gate of the detection signal outputting transistor T5. Therefore, also the voltage of the light detection line DETL varies to a potential given by Vx−ΔVa.

By the coupling, a potential difference appears between the source and the drain of the sensor serving transistor T10 and varies the leak amount of the sensor serving transistor T10 depending upon the received light amount. However, the leak current at this time little varies the gate voltage of the detection signal outputting transistor T5. This arises from the facts that the potential difference between the source and the drain of the sensor serving transistor T10 is small and that the time before a next operation of varying the power supply line VL from the reference potential Vini to the power supply voltage Vcc is short.

At time tm6 after a fixed period of time elapses, the potential of the power supply line VL are changed from the reference potential Vini to the power supply voltage Vcc.

By this operation, the coupling from the power supply line VL is inputted to the gate of the detection signal outputting transistor T5, and consequently, the gate potential of the detection signal outputting transistor T5 rises. Since the potential of the power supply line VL varies to the high potential, a great potential difference appears between the source and the drain of the sensor serving transistor T10, and leak current flows from the power supply line VL to the gate of the detection signal outputting transistor T5 in response to the received light amount.

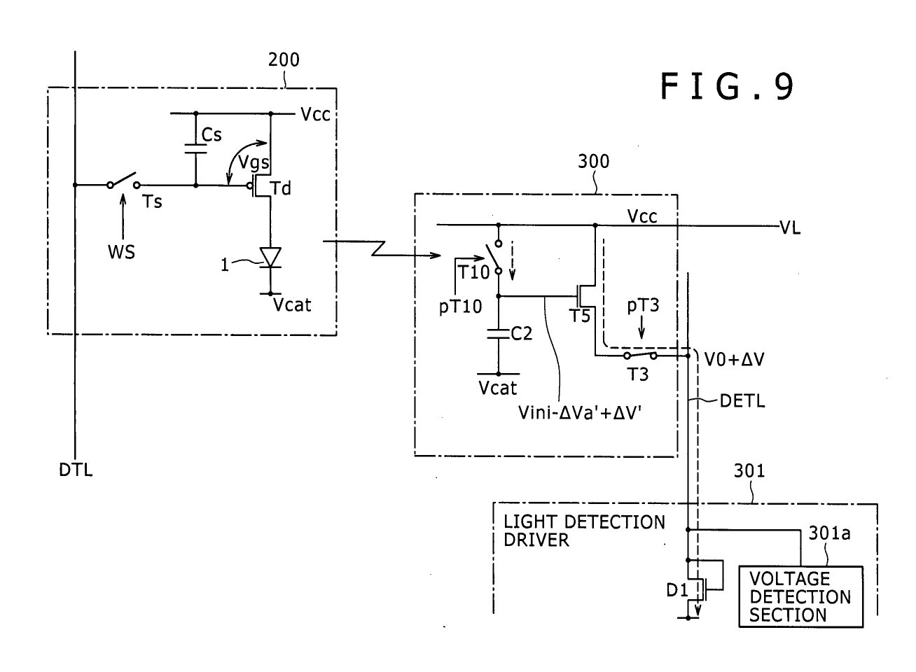

This state is illustrated in FIG. 9. By the operation described, the gate voltage of the detection signal outputting transistor T5 varies from Vini−ΔVa′ to Vini−ΔVa′+ΔV′. FIG. 5 illustrates a manner wherein the gate potential of the detection signal outputting transistor T5 gradually rises from Vini−ΔVa′ after time tm6.

Together with this, also the potential of the light detection line DETL rises from the potential Vx−ΔVa to V0+ΔV. It is to be noted that the potential V0 is a potential of the light detection line DETL in a low gradation displaying state, that is, in a black displaying state. Since the amount of current flowing to the sensor serving transistor T10 increases as the amount of light received by the sensor serving transistor T10 increases, the voltage of the light detection line DETL upon a high gradation display is higher than that upon a low gradation display.

This potential variation of the light detection line DETL is detected by the voltage detection section 301a. This detection voltage corresponds to the emitted light amount of the organic EL element 1. In other words, if a particular gradation display such as, for example, a white display is being executed by the pixel circuit 10, then the detection potential represents a degree of degradation of the organic EL element 1.

After lapse of a fixed interval of time, the control pulse pT3 is set to the L level at time tm7 to turn off the switching transistor T3 thereby to end the detection operation. Consequently, no more current is supplied to the light detection line DETL, and the potential becomes equal to Vcat+VthD1. It is to be noted that VthD1 represents a threshold voltage of the diode D1.

For example, detection with regard to the pixel circuits 10 of the pertaining line within one frame is carried out in the following manner.

With the light detection section 300 which carries out such a light detection operation as described above, a more accurate light detection operation than the configuration example 1 described above can be achieved.

In particular, the detection signal outputting circuit of the light detection section 300 has a configuration of a source follower circuit, and if the gate voltage of the detection signal outputting transistor T5 varies, then the variation is outputted from the source of the detection signal outputting transistor T5. In other words, the variation of the gate voltage of the detection signal outputting transistor T5 by variation of leak current of the sensor serving transistor T10 is outputted from the source of the detection signal outputting transistor T5 to the light detection line DETL. Meanwhile, the gate-source voltage Vgs of the detection signal outputting transistor T5 is set so as to be higher than the threshold voltage Vth of the detection signal outputting transistor T5. Therefore, the value of current outputted from the detection signal outputting transistor T5 is much higher than that of the circuit configuration described hereinabove with reference to FIG. 2, and even if the value of leak current is low, since it passes the detection signal outputting transistor T5, detection information of the emitted light amount can be outputted to the light detection driver 201.

Therefore, although a light detection operation of high accuracy is possible, the light detection section 300 is formed from an increased number of elements. In particular, the light detection section 200 may require the three transistors T3, T5 and T10, and the capacitor C1, and this gives rise to increase of the number of elements per one pixel and increase of the ratio of transistors including the pixel circuit 200.

Also, since the control lines TLb and TLa for the transistors T10 and T3 are required and the power supply line VL is used as a pulse voltage power supply, three control systems are required for one light detection section 300. That is, this configuration has a drawback that the number of drivers for driving the control lines increases.

These make a cause of a low yield.

Taking the foregoing into consideration, the embodiments of the present invention make it possible to simplify the configuration of a pixel circuit and a light detection section and achieve a high yield while maintaining the feature that light detection can be carried out with a high degree of accuracy similarly as with the configuration example 2.

### 3. First Embodiment

### 3-1. Circuit Configuration

A configuration of a pixel circuit 10 and the light detection driver 22 in the organic EL display apparatus of the first embodiment described hereinabove with reference to FIG. 1 is shown in FIG. 10. FIG. 10 particularly shows one pixel circuit 10 disposed at a crossing point between a signal line DTL and a writing control line WSL. Further, as regard the light detection driver 22, part corresponding to one light detection line DETL to which the pixel circuit 10 is connected is shown.

The pixel circuit 10 of FIG. 10 includes a driving transistor Td, a sampling transistor Ts and a switching transistor T3 all in the form of an n-channel TFT. The pixel circuit 10 further includes a holding capacitor Cs and an organic EL element 1.

The pixel circuit 10 has not only a function as a light emitting pixel but also a light detection function.

The signal line DTL is connected to the drain of the sampling transistor Ts while the writing control line WSL is connected to the gate of the sampling transistor Ts.

The driving transistor Td and the organic EL element 1 are connected in series between a power supply potential Vcc and a cathode potential Vcat.

The sampling transistor Ts is connected to the gate of the driving transistor Td. The holding capacitor Cs is connected between the power supply potential Vcc and the gate of the driving transistor Td.

The switching transistor T3 is connected between the source of the driving transistor Td and the light detection line DETL.

In the light detection driver 22, potential detection of the light detection line DETL is carried out by a voltage detection section 22a.

A switch SW is connected to the light detection line DETL. The switch SW is connected to a fixed power supply whose potential is Vss. The switch SW is turned on/off in with a control signal pSW from the detection operation control section 21 shown in FIG. 1. When the switch SW is on, the light detection line DETL is charged to the potential Vss.

It is to be noted that the light detection driver 22 may be configured otherwise using a diode D1 as in the example shown in FIG. 4.

In the present pixel circuit 10 of FIG. 10, when the horizontal selector 11 applies a signal value corresponding to a luminance signal to the signal line DTL, if the write scanner 12 places the scanning pulse WS of the writing control line WSL to the H level, then the sampling transistor Ts is rendered conducting and the signal value is inputted to the gate of the driving transistor Td, that is, written into the holding capacitor Cs. The signal value potential written in the holding capacitor Cs becomes the gate potential of the driving transistor Td.

If the write scanner 12 places the scanning pulse WS of the writing control line WSL into the L level, then although the signal line DTL and the driving transistor Td are electrically disconnected from each other, the gate potential of the driving transistor Td is held stably by the holding capacitor Cs.

Then, driving current Ids flows to the driving transistor Td and the organic EL element 1 so as to be directed from the power supply voltage Vcc toward the cathode potential Vcat.

At this time, the driving current Ids exhibits a value corresponding to the gate-source voltage Vgs of the driving transistor Td, and the organic EL element 1 emits light with a luminance corresponding to the current value.

Thus, in the present example, the sampling transistor Ts functions as a light detection element. In particular, the sampling transistor Ts is used, in the on state thereof, as a sampling transistor for inputting the potential of the signal line DTL to the gate of the driving transistor Td but is used, in the off state thereof, as a light detection element.

In order to allow the sampling transistor Ts to function as a light detection element, the sampling transistor Ts is laid out so that it can receive light more readily than the other transistors. In particular, the sampling transistor Ts is structured such that light to the channel layer thereof is not relatively blocked by a metal layer which exists above the substrate in comparison with the other transistors. In other words, the sampling transistor Ts is formed such that light is introduced to the channel layer. In the sampling transistor Ts, when it is in the off state, leak current increases or decreases in response to the amount of received light. In particular, where the received light amount is great, the increasing amount of the leak current is great, but where the received light amount is small, the increasing amount of the leak current is small.

The gate potential of the driving transistor Td is varied by the leak current of the sampling transistor Ts.

In other words, the pixel circuit 10 is configured such that it can execute a light detection operation of varying the gate potential of the driving transistor Td in response to the received light amount of the sampling transistor Ts in the off state so that the source potential of the driving transistor Td based on the variation is outputted to the light detection line DETL through the switching transistor T3.

### 3-2. Light Detection Operation Example A

Various light detection operations may be carried out by the pixel circuit 10 of FIG. 10. In particular, an operation of detecting the luminance of emitted light of the pixel circuit 10 itself, another operation of detecting the luminance of emitted light of a neighboring pixel circuit 10 and so forth may be possible.

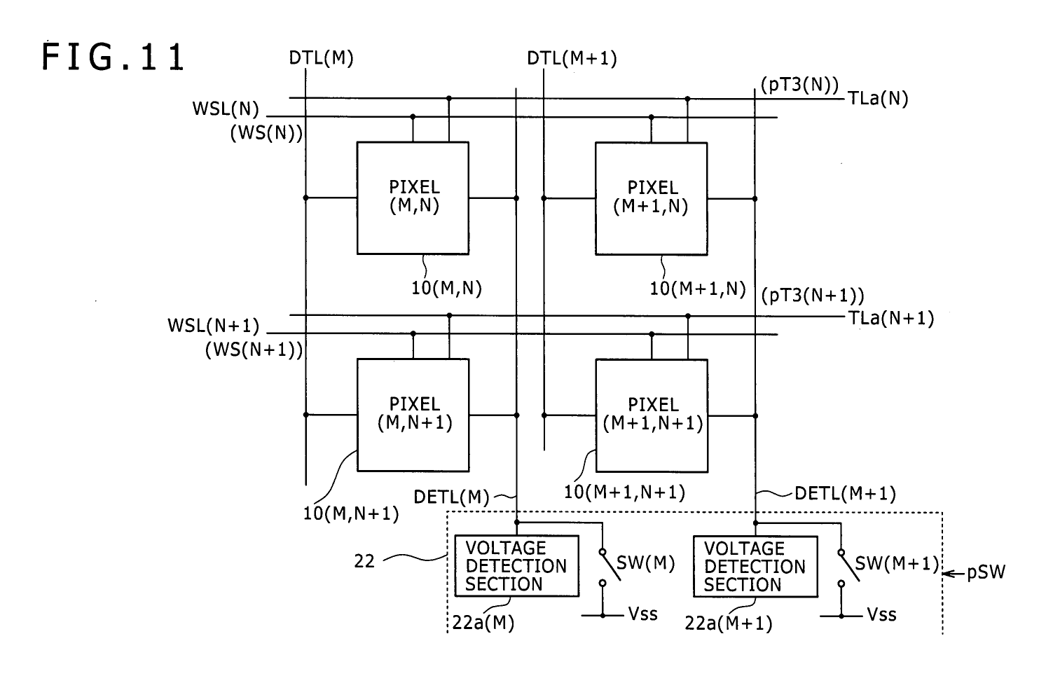

For the convenience of description, reference characters of FIG. 11 are used.

FIG. 11 shows certain four pixel circuits 10. Using reference characters M and N for a column and a row, respectively, the four pixel circuits 10 are denoted by 10(M, N), 10(M+1, N), 10(M, N+1) and 10(M+1, N+1).

As regards the signal lines DTL, the signal line for the Mth column is denoted by DTL(M) and the signal line for the M+1th column is denoted by DTL(M+1). Also the light detection lines DETL are denoted by DETL(M) and DETL(M+1). Also the voltage detection sections 22a and the switches SW in the light detection driver 22 are identified with M and M+1 applied thereto.

As regards the writing control lines WSL, the writing control line WSL for the Nth line is denoted by WSL(N) and the writing control line WSL for the N+1th line is denoted by WSL(N+1). Also scanning pulses on the writing control lines WSL(N) and WSL(N+1) are noted by WS(N) and WS(N+1), respectively.

Also the control lines TLa are denoted by TLa(N) and TLa(N+1) similarly, and also the control pulses are denoted by pT3(N) and pT3(N+1).

Further, though not indicated in FIGS. 10 and 11, where it is intended to clearly distinguish reference characters Ts, Td, T3, Cs and 1 of the elements in the pixel circuit 10, “(M, N),” “(M+1, N)” and so forth are applied. For example, the sampling transistor Ts of the pixel circuit 10(M, N) may be represented by “Ts(M, N).”

First, as a light detection operation example A, an operation example of self detection is described. For example, this is a case in which the emitted light amount of the pixel circuit 10(M, N) is detected by the pixel circuit 10(M, N) itself.

It is to be noted that, since all elements in the pixel circuit 10 described in regard to the light detection operation example A are all included in the pixel circuit 10(M, N), they are represented not by “Ts(M, N)” or the like but merely by “Ts” or the like.

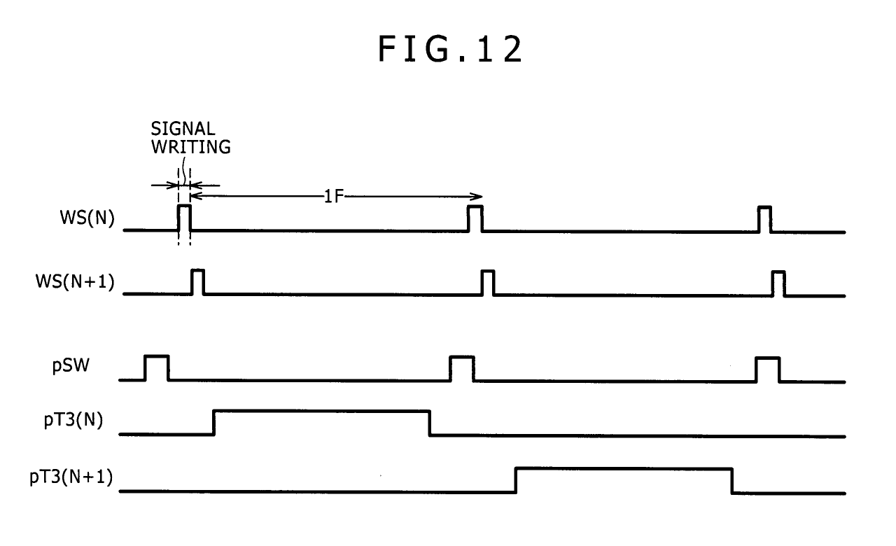

FIG. 12 illustrates a scanning pulse WS(N) to be applied from the write scanner 12 to the Nth writing control line WSL(N) and a scanning pulse WS(N+1) to be applied from the write scanner 12 to the N+1th writing control line WSL(N+1).

Further, FIG. 12 illustrates a control signal pSW for controlling the switch SW in the light detection driver 22 between on and off. Further, FIG. 12 illustrates a control pulse pT3(N) to be applied from the detection operation control section 21 to the Nth control line TLa(N) and a control pulse pT3(N+1) to be applied from the detection operation control section 21 to the N+1th control line TLa(N+1).

It is assumed that light detection is carried out once within a period of one frame.

In the pixel circuit 10(M, N), when the potential of the scanning pulse WS(N) becomes the H level, a signal value Vsig applied to the signal line DTL(M) is inputted to the gate of the driving transistor Td through the sampling transistor Ts. Then, light emission in accordance with the signal value Vsig is carried out. In order to detect the amount of light emitted thereupon, initialization of the light detection line DETL by the control signal pSW and turning-on control of the switching transistor T3 by the control pulse pT3(N) are carried out.

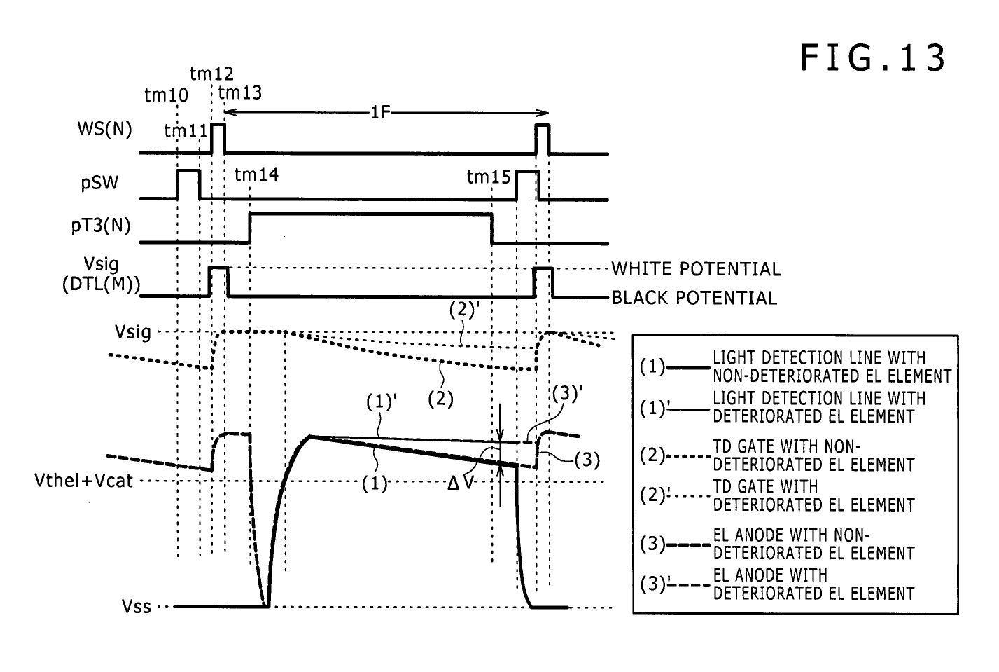

Waveforms within a period of one frame of FIG. 12, that is, within a self detection period by the pixel circuit 10(M, N), are illustrated in FIG. 13.

In FIG. 13, the scanning pulse WS(N), control signal pSW, control pulse pT3(N) and signal value Vsig applied to the signal line DTL(M) are illustrated. Further, potential variations are illustrated in such a manner as given below:

Waveform (1): potential of the light detection line DETL when the organic EL element 1 does not suffer from deterioration
Waveform (1)′: potential of the light detection line DETL when the organic EL element 1 suffers from deterioration
Waveform (2): gate potential of the driving transistor Td when the organic EL element 1 does not suffer from deterioration
Waveform (2)′: gate potential of the driving transistor Td when the organic EL element 1 suffers from deterioration
Waveform (3): anode potential of the organic EL element 1 when the organic EL element 1 does not suffer from deterioration
Waveform (3)′: anode potential of the organic EL element 1 when the organic EL element 1 suffers from deterioration

It is to be noted that, as an example, it is assumed that the period within which a light detection operation is carried out in FIG. 13 is one frame and light emission is carried out only on the Nth row. In short, as seen in FIG. 13, only at a point of time within a period from time tm12 to time tm13 within which the scanning pulse WS(N) for the Nth row has the H level, the signal value Vsig applied to the signal lines DTL has the high potential, that is, the white potential. On the other hand, within any other period within the frame, that is, within a period within which signal writing is carried out for the other rows, the signal value Vsig has the low potential, that is, the black potential.

A light detection operation by the pixel circuit 10(M, N) within a period of one frame is such as follows.

Within a period from time tm10 to time tm11, the switch SW(M) is turned on by the control signal pSW so that the signal line DETL(M) is charged to the potential Vss.

Within a period from time tm12 to time tm13, the scanning pulse WS(N) exhibits the on state and the signal value Vsig of the white potential is applied to the signal line DTL(M). Therefore, the signal value Vsig of the white level is inputted to the gate of the driving transistor Td through the sampling transistor Ts which is controlled to the on state by the scanning pulse WS(N). At this time, current flows from the power supply potential Vcc to the cathode potential Vcat, and consequently, the organic EL element 1 begins to emit light.

Thereafter, at time tm14, the control pulse pT3(N) is set to the H level to turn on the switching transistor T3. In other words, the anode of the organic EL element 1, and hence the source of the driving transistor Td, and the light detection line DETL are connected to each other.

Since the light detection line DETL was charged to the potential Vss within the period from time tm10 to tm11, by turning on the switching transistor T3, the anode potential of the organic EL element 1 drops to the potential Vss and the organic EL element 1 temporarily stops the emission of light. However, since the switch SW is not in an on state, the anode potential of the organic EL element 1 begins to rise gradually.

Here, preferably the potential Vss is set to a potential with which the organic EL element 1 does not emit light from the point of view of the contrast. In particular, it is demanded to set the potential Vss lower than the sum of the cathode potential Vcat and the threshold voltage Vthel of the organic EL element 1, that is, it is demanded to satisfy Vss <Vcat+Vthel.

After lapse of a fixed period of time, if the potential of the anode of the organic EL element 1 exceeds the sum of the cathode potential Vcat and the threshold voltage Vthel of the EL element, then the organic EL element 1 begins to emit light again.

Here, as described hereinabove, the sampling transistor Ts operates as a light detection element when it is off. Therefore, the leak amount varies in response to light incident to the channel of the sampling transistor Ts. In other words, where the light emitted from the organic EL element 1 is blight, the leak amount is high as much, and the variation of the gate potential of the driving transistor Td is great. On the other hand, where the light emitted from the organic EL element 1 is dark, the leak current is small, and the potential variation of the gate potential of the driving transistor Td is small.

Further, also the value of the source potential of the driving transistor Td, that is, the value of the anode potential of the organic EL element 1 and the potential of the light detection line DETL, varies.

Consequently, after lapse of a fixed period of time, the potential of the light detection line DETL exhibits a variation ΔV depending upon whether or not the organic EL element 1 suffers from deterioration, and the potential difference is detected by the voltage detection section 22a.

In particular, as seen in FIG. 13, if the organic EL element 1 does not suffer from deterioration and the luminance of emitted light in accordance with the signal value Vsig which is the original white potential is maintained, then the emitted light amount is great and the leak current of the sampling transistor Ts is great. Therefore, the gate potential variation is great as seen from the waveform (2). On the other hand, if the emitted light luminance exhibits a drop due to the deterioration of the organic EL element 1, then the gate potential variation is small as seen from the waveform (2)′.

This appears as the potential of the light detection line DETL like the waveforms (1) and (1)′. Accordingly, by detecting the voltage of the light detection line DETL by means of the voltage detection section 22a, the received light amount by the sampling transistor Ts can be detected. If the emitted light luminance of the organic EL element 1, for example, the light amount in accordance with the signal value Vsig to be applied, is known, then the difference ΔV represents information of the deterioration of the organic EL element 1. Naturally, it is possible to use the difference ΔV as information of the emitted light amount.

### 3-3. Light Detection Operation Example B

Subsequently, as a light detection operation example B, a leftwardly or rightwardly neighboring emitted light detection operation of detecting emitted light from the pixel circuit 10(M, N) by means of the pixel circuit 10(M+1, N) in the same row is described.

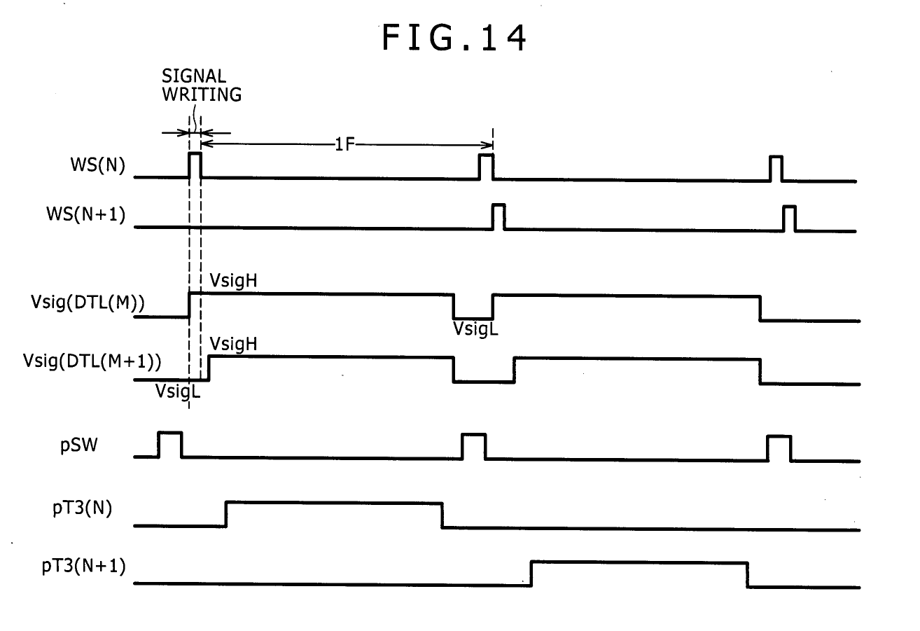

FIG. 14 illustrates a scanning pulse WS(N) applied to the writing control line WSL(N) of the Nth row from the write scanner 12 and a scanning pulse WS(N+1) applied to the writing control line WSL(N+1) of the N+1th row from the write scanner 12.

FIG. 14 further illustrates signal values applied to the signal lines DTL(M) and DTL(M+1) from the horizontal selector 11.

FIG. 14 further illustrates a control signal pSW from the detection operation control section 21 for controlling the switch SW in the light detection driver 22 between on and off. Furthermore, FIG. 14 illustrates a control pulse pT3(N) applied to the control line TLa(N) of the Nth row from the detection operation control section 21 and a control pulse pT3(N+1) to be applied to the control line TLa(N+1) of the N+1th row from the detection operation control section 21.

It is assumed that light detection is carried out once within a period of one frame.

In this instance, the pixel circuit 10(M, N) executes light emission and the emitted light amount of the pixel circuit 10(M, N) is detected by the pixel circuit 10(M+1, N).

The horizontal selector 11 applies a signal value VsigH of the high level, that is, the white level and a signal value VsigL of the low level, that is, the black level at predetermined timings to the signal lines DTL.

When the level of the scanning pulse WS(N) becomes the H level in FIG. 14, the signal value VsigH applied to the signal line DTL(M) is inputted to the gate of the driving transistor Td(M, N) through the sampling transistor Ts(M, N) of the pixel circuit 10(M, N). Then, the organic EL element 1(M, N) emits light in accordance with the signal value VsigH.

Also in the adjacent pixel circuit 10(M+1, N) in the same row, the sampling transistor Ts(M+1, N) is turned on when the level of the scanning pulse WS(N) changes to the H level. However, at this time, the signal value VsigL of the black potential is applied to the signal line DTL(M+1). Accordingly, the pixel circuit 10(M+1, N) does not emit light.

In other words, the leftwardly or rightwardly neighboring emitted light detection operation allows the pixel circuit 10(M, N) to carry out light emission while it does not allow the adjacent pixel circuit 10(M+1, N), which carries out light detection operation, to emit light. In this state, for the light detection by the pixel circuit 10(M+1, N), initialization of the light detection line DETL with the control signal pSW and turning on control of the switching transistor T3(M+1, N) by the control pulse pT3(N) are carried out.

It is to be noted that, while, in FIG. 14, the level of the scanning pulse WS(N) is changed to the H level again at the end of the one frame, that is, after the light detection operation, at this time, both of the signal lines DTL(M) and DTL(M+1) have the signal value VsigL. According, in both of the pixel circuits 10(M, N) and 10(M+1, N), the black potential is written into the gate of the driving transistor Td so that no light emission is carried out. In other words, the light emission of the pixel circuit 10(M, N) is stopped. Thereafter, light emission and light detection in the next row are carried out with the scanning pulse WS(N+1).

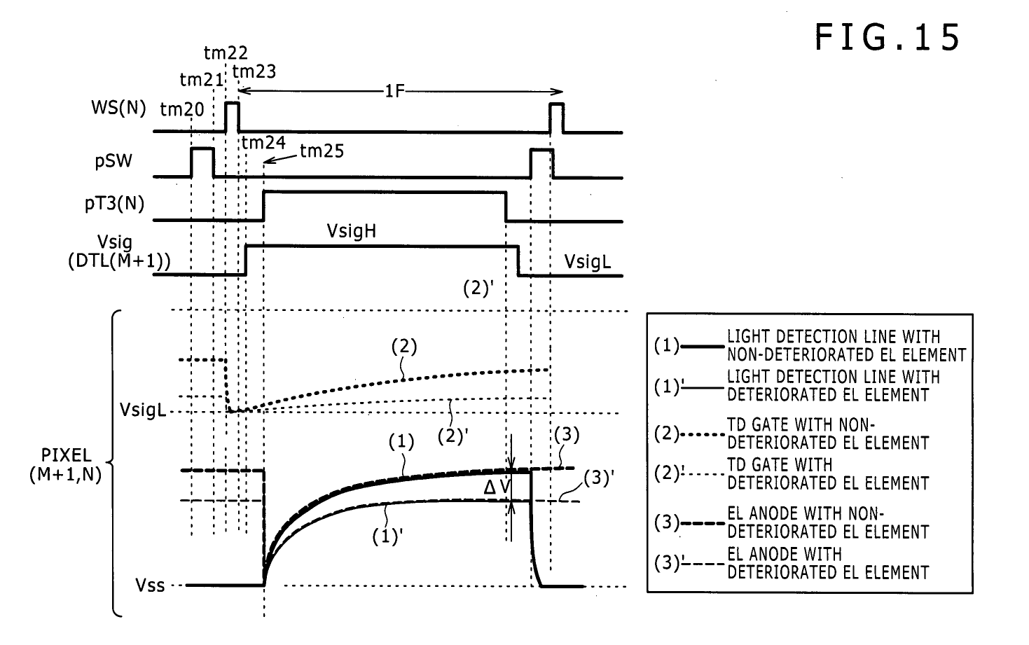

Waveforms within the period of one frame, that is, within the light detection period by the pixel circuit 10(M+1, N), in the FIG. 14, are shown in FIG. 15.

Particularly, FIG. 15 illustrates the scanning pulse WS(N), control signal pSW, control pulse pT3(N), and signal value Vsig applied to the signal line DTL(M+1).

Further, while FIG. 15 shows waveforms (1), (1)′, (2), (2)′, (3) and (3)′ similarly as in FIG. 13, they indicate potential variations of the pertaining portions on the pixel circuit 10(M+1, N) side in accordance with the degree of degradation of the pixel circuit 10(M, N).

In particular, the waveforms (1) and (1)′ indicate potentials of the light detection line DETL(M+1) based on whether or not the organic EL element 1(M, N) suffers from deterioration.

The waveforms (2) and (2)′ indicate gate potentials of the driving transistor Td(M+1, N) based on whether or not the organic EL element 1(M, N) suffers from deterioration.

The waveforms (3) and (3)′ indicate anode potentials of the organic EL element 1(M+1, N) based on whether or not the organic EL element 1(M, N) suffers from deterioration.

A light detection operation by the pixel circuit 10(M+1, N) within a period of one frame is such as follows.

In particular, within a period from time tm20 to time tm21, the switch SW(M+1) is turned on with the control signal pSW to charge the light detection line DETL(M+1) to the potential Vss.

Within a period from time tm22 to tm23, the scanning pulse WS(N) exhibits an on state, and the signal value VsigH of the white potential is applied to the signal line DTL(M) as illustrated in FIG. 14. Therefore, in the pixel circuit 10(M, N), the signal value VsigH of the white potential is inputted to the gate of the driving transistor Td(M, N) through the sampling transistor Ts(M, N). Accordingly, current flows from the power supply potential Vcc to the cathode potential Vcat and the organic EL element 1(M, N) begins to emit light.

Meanwhile, at this time, the signal value VsigL of the black potential is applied to the signal line DTL(M+1). Therefore, in the pixel circuit 10(M+1, N) which is to carry out light detection, the signal value VsigL of the black potential is applied to the gate of the driving transistor Td(M+1, N) through the sampling transistor Ts(M+1, N). Accordingly, the pixel circuit 10(M+1, N) does not emit light.

At time tm24 after the level of the scanning pulse WS(N) is changed to the L level at time tm23, the horizontal selector 11 changes the potential of the signal line DTL(M+1) from the black potential VsigL to the white potential VsigH which is the high potential. Here, the signal value VsigH is the potential of the white display, and although this is preferable, the signal value VsigH is not necessarily limited to the white potential.

By the operation described, a potential difference of VsigH−VsigL appears between the source and the drain of the sampling transistor Ts(M+1, N), that is, between the gate potential of the driving transistor Td(M+1, N) and the potential of the signal line DTL(M+1).

Further, since the adjacent pixel circuit 10(M, N) emits light as described above, the leak amount of the sampling transistor Ts(M+1, N) which operates as a light detection element varies in response to light incident to the cannel of the sampling transistor Ts(M+1, N).

As seen in FIG. 15, the gate potential of the driving transistor Td(M+1, N) undergoes a variation by an influence of the leak current after time tm24.

At time tm25, the control pulse pT3(N) is set to the H level to turn on the switching transistor T3(M+1, N). In other words, the anode of the organic EL element 1(M+1, N), and hence the source of the driving transistor Td(M+1, N), and the light detection line DETL(M+1) are connected to each other.

Since the light detection line DETL(M+1) was charged to the potential Vss within the period from time tm20 to time tm21, when the switching transistor T3(M+1, N) is turned on, the anode potential of the organic EL element 1(M+1, N) drops to the potential Vss. However, at this time, since the switch SW is not on, if the gate-source voltage Vgs of the driving transistor Td(M+1, N) is higher than the threshold voltage of the driving transistor Td(M+1, N), then the anode potential of the organic EL element 1(M+1, N) begins to gradually rise.

It is to be noted that it is necessary to set the potential Vss such that the gate-source voltage Vgs of the driving transistor Td(M+1, N) is higher than the threshold voltage of the driving transistor Td(M+1, N) as described above.

In this instance, if the brightness of light incident to the sampling transistor Ts(M+1, N) is high, then the leak current is high and the variation amount of the gate potential of the driving transistor Td(M+1, N) is great. On the other hand, if the brightness of the light is low, then the leak current is low and the variation amount of the gate potential of the driving transistor Td(M+1, N) is small (refer to the waveforms (2) and (2)′ of FIG. 15).

Also the source potential of the driving transistor Td(M+1, N), and hence the anode potential of the organic EL element 1(M+1, N), and the potential of the light detection line DETL(M+1) vary in an interlocking relationship with the variation of the gate potential of the driving transistor Td(M+1, N) (refer to the waveforms (1), (3), (1)′ and (3)′ of FIG. 15.

Consequently, after lapse of a fixed period of time, the potential of the light detection line DETL(M+1) exhibits a difference ΔV depending upon whether or not the organic EL element 1(M, N) of the adjacent pixel circuit 10(M, N) suffers from deterioration. The resulting difference ΔV is detected by the voltage detection section 22a (M+1).

In this manner, the leftwardly or rightwardly neighboring emitted light detection operation of detecting emitted light from the pixel circuit 10(M, N) by means of the pixel circuit 10(M+1, N) in the same row is carried out.

### 3-4. Light Detection Operation Example C

Subsequently, as a light detection operation example C, a upwardly or downwardly neighboring emitted light detection operation of detecting emitted light from the pixel circuit 10(M, N) by means of the pixel circuit 10(M, N+1) in the same row is described.

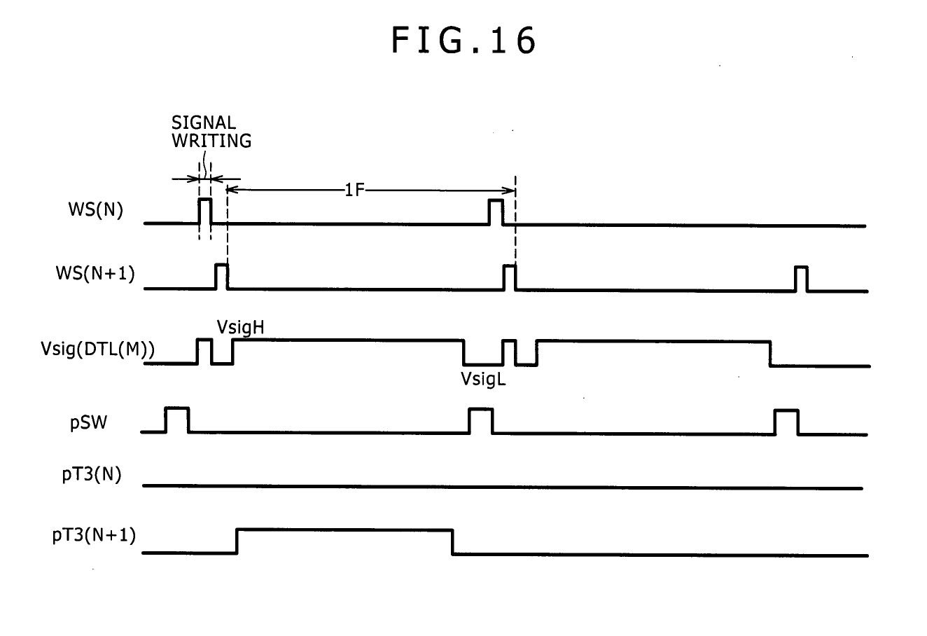

FIG. 16 illustrates a scanning pulse WS(N) applied to the writing control line WSL(N) of the Nth row from the write scanner 12 and a scanning pulse WS(N+1) applied to the writing control line WSL(N+1) of the N+1th row from the write scanner 12.

FIG. 16 further illustrates signal values applied to the signal lines DTL(M) from the horizontal selector 11.

FIG. 16 further illustrates a control signal pSW from the detection operation control section 21 for controlling the switch SW in the light detection driver 22 between on and off. Furthermore, FIG. 16 illustrates a control pulse pT3(N) applied to the control line TLa(N) of the Nth row from the detection operation control section 21 and a control pulse pT3(N+1) to be applied to the control line TLa(N+1) of the N+1th row from the detection operation control section 21.

It is assumed that light detection is carried out once within a period of one frame.

In this instance, the pixel circuit 10(M, N) executes light emission and the emitted light amount of the pixel circuit 10(M, N) is detected by the pixel circuit 10(M+1, N).

The horizontal selector 11 applies a signal value VsigH of the high level, that is, the white potential and a signal value VsigL of the low level, that is, the black potential at predetermined timings to the signal lines DTL.

When the level of the scanning pulse WS(N) becomes the H level in FIG. 16, the signal value VsigH applied to the signal line DTL(M) is inputted to the gate of the driving transistor Td(M, N) through the sampling transistor Ts(M, N) of the pixel circuit 10(M, N). Then, the organic EL element 1(M, N) emits light in accordance with the signal value VsigH.

Also in the adjacent pixel circuit 10(M, N+1) in the same row, the sampling transistor Ts(M, N+1) is turned on when the level of the scanning pulse WS(N+1) changes to the H level. However, at this time, the signal value VsigL of the black potential is applied to the signal line DTL(M). Accordingly, the pixel circuit 10(M, N+1) does not emit light.

In other words, the upwardly or downwardly neighboring emitted light detection operation allows the pixel circuit 10(M, N) to carry out light emission while it does not allow the adjacent pixel circuit 10(M, N+1), which carries out light detection operation, to emit light. In this state, for the light detection by the pixel circuit 10(M, N+1), initialization of the light detection line DETL with the control signal pSW and turning on control of the switching transistor T3(M, N+1) by the control pulse pT3(N+1) are carrier out.

It is to be noted that, while, in FIG. 16, the level of the scanning pulse WS(N) is changed to the H level against at the end of the one frame, that is, after the light detection operation, at this time, both of the signal lines DTL(M) have the signal value VsigL. Accordingly, in both of the pixel circuits 10(M, N), the black potential is written into the gate of the driving transistor Td so that no light emission is carried out. In other words, the light emission of the pixel circuit 10(M, N) is stopped.

Immediately after then, the signal line DTL(M) is set to the signal value VsigH and the scanning pulse WS(N+1) is set to the H level. Consequently, the signal value VsigH is written into the pixel circuit 10(M, N+1) and light emission is started. In short, within a period of a next frame, operation of detecting the emitted light amount of the pixel circuit 10(M, N+1) is carried out by the pixel circuit 10(M, N+2) not shown.

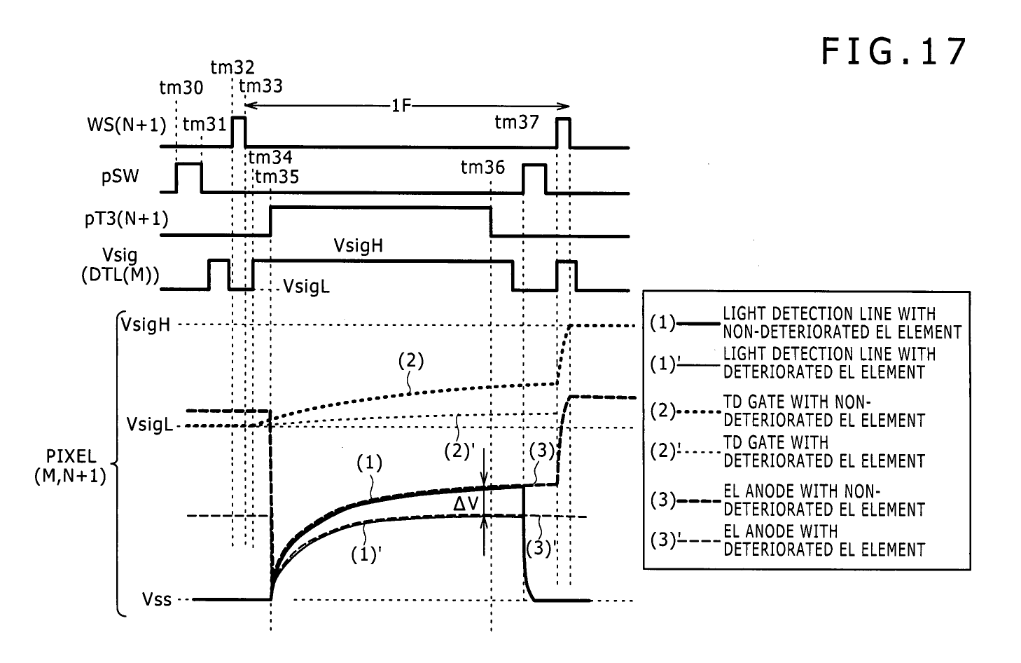

Waveforms within the period of one frame, that is, within the light detection period by the pixel circuit 10(M, N+1), in the FIG. 16, are shown in FIG. 17.

Particularly, FIG. 17 illustrates the scanning pulse WS(N+1), control signal pSW, control pulse pT3(N+1), and signal value Vsig applied to the signal line DTL(M).

Further, while FIG. 17 shows waveforms (1), (1)′, (2), (2)′, (3) and (3)′ similarly as in FIGS. 13, 15, they indicate potential variations of the pertaining portions on the pixel circuit 10(M, N+1) side in accordance with the degree of degradation of the pixel circuit 10(M, N).

In particular, the waveforms (1) and (1)′ indicate potentials of the light detection line DETL(M) based on whether or not the organic EL element 1(M, N) suffers from deterioration.

The waveforms (2) and (2)′ indicate gate potentials of the driving transistor Td(M, N+1) based on whether or not the organic EL element 1(M, N) suffers from deterioration.

The waveforms (3) and (3)′ indicate anode potentials of the organic EL element 1(M, N+1) based on whether or not the organic EL element UM, N) suffers from deterioration.

A light detection operation by the pixel circuit 10(M, N+1) within a period of one frame is such as follows.

In particular, within a period from time tm30 to time tm31, the switch SW(M) is turned on with the control signal pSW to charge the light detection line DETL(M) to the potential Vss.

Within a period from time tm32 to tm33, the scanning pulse WS(N+1) exhibits an on state, and the signal value VsigL of the black potential is applied to the signal line DTL(M). Therefore, in the pixel circuit 10(M, N+1), the signal value VsigL of the black potential is inputted to the gate of the driving transistor Td(M, N+1) through the sampling transistor Ts(M, N+1). Accordingly, the pixel circuit does not emit light.

Meanwhile, at a timing preceding to time tm32, the signal value VsigH of the white potential is applied to the signal line DTL(M).

As shown in FIG. 16, since the scanning pulse WS(N) for the pixel circuit 10(M, N) is turned on at this time, in the pixel circuit 10(M, N), the signal value Vsig of the white potential is inputted to the gate of the driving transistor Td(M, N) through the sampling transistor Ts(M, N). Accordingly, current flows from the power supply potential Vcc to the cathode potential Vcat and the organic EL element 1(M, N) begins to emit light.

At time tm34 after the level of the scanning pulse WS(N+1) is changed to the L level at time tm33, the horizontal selector 11 changes the potential of the signal line DTL(M) from the black potential VsigL to the white potential VsigH which is the high potential. Here, the signal value VsigH is the potential of the white display, and although this is preferable, the signal value VsigH is not necessarily limited to the white potential.

By the operation described, a potential difference of VsigH−VsigL appears between the source and the drain of the sampling transistor Ts(M, N+1), that is, between the gate potential of the driving transistor Td(M, N+1) and the potential of the signal line DTL(M).

Further, since the adjacent pixel circuit 10(M, N) emits light as described above, the leak amount of the sampling transistor Ts(M, N+1) which operates as a light detection element varies in response to light incident to the cannel of the sampling transistor Ts(M, N+1).

As seen in FIG. 17, the gate potential of the driving transistor Td(M, N+1) undergoes a variation by an influence of the leak current after time tm34.

At time tm35, the control pulse pT3(N+1) is set to the H level to turn on the switching transistor T3(M, N+1). In other words, the anode of the organic EL element 1(M, N+1), and hence the source of the driving transistor Td(M, N+1), and the light detection line DETL(M) are connected to each other.

Since the light detection line DETL(M) was charged to the potential Vss within the period from time tm30 to time tm31, when the switching transistor T3(M, N+1) is turned on, the anode potential of the organic EL element 1(M, N+1) drops to the potential Vss. However, at this time, since the switch SW is not on, if the gate-source voltage Vgs of the driving transistor Td(M, N+1) is higher than the threshold voltage of the driving transistor Td(M, N+1), then the anode potential of the organic EL element 1(M, N+1) begins to gradually rise.

It is to be noted that it is necessary to set the potential Vss such that the gate-source voltage Vgs of the driving transistor Td(M, N+1) is higher than the threshold voltage of the driving transistor Td(M, N+1) as described above.

In this instance, if the brightness of light incident to the sampling transistor Ts(M, N+1) is high, then the leak current is high and the variation amount of the gate potential of the driving transistor Td(M, N+1) is great. On the other hand, if the brightness of the light is low, then the leak current is low and the variation amount of the gate potential of the driving transistor Td(M, N+1) is small (refer to the waveforms (2) and (2)′ of FIG. 17).

Also the source potential of the driving transistor Td(M, N+1), and hence the anode potential of the organic EL element 1(M, N+1), and the potential of the light detection line DETL(M) vary in an interlocking relationship with the variation of the gate potential of the driving transistor Td(M, N+1) (refer to the waveforms (1), (3), (1)′ and (3)′ of FIG. 17.

Consequently, after lapse of a fixed period of time, the potential of the light detection line DETL(M+1) exhibits a difference ΔV depending upon whether or not the organic EL element 1(M, N) of the adjacent pixel circuit 10(M, N) suffers from deterioration. The resulting difference ΔV is detected by the voltage detection section 22a (M).

In this manner, the upwardly or downwardly neighboring emitted light detection operation of detecting emitted light from the pixel circuit 10(M, N) by means of the pixel circuit 10(M, N+1) in the same column is carried out.

While the light detection operation examples A, B and C of the first embodiment are described, in the present embodiment, the sampling transistor Ts is structured such that it functions as a light sensor when it is in an off state. Further, as the light detection operation, when the sampling transistor Ts is in an off state, leak current corresponding to the received light amount is applied to the gate of the driving transistor Td. Consequently, the gate potential of the driving transistor Td is varied in response to the received light amount. While the source potential of the driving transistor Td and hence the anode potential of the organic EL element 1 varies in response to the gate potential variation, the source potential is outputted to the light detection line DETL through the switching transistor T3.

Further, prior to the detection operation, the light detection line DETL is charged to the potential Vss with which the light emitting element does not emit light.

Accordingly, the light detection driver 22 can detect information of the received light amount by the sampling transistor Ts as a voltage variation of the light detection line DETL.

Particularly in the light detection operation example A, the sampling transistor Ts receives light of the organic EL element 1 in the pixel circuit 10 in which the sampling transistor Ts is provided to carry out a light detection operation.

On the other hand, in the light detection operations B and C, the sampling transistor Ts receives light of the organic EL element 1 in a neighboring pixel circuit 10 and carries out a light detection operation.

In the present embodiment having the configuration described above, since the sampling transistor Ts connected to the gate of the driving transistor Td is used, when it is in an on state, for signal writing but is used, when it is in an off state, as a light detection element, a high yield can be implemented by a small number of elements.

Further, since it is possible to decide deterioration of the organic EL element 1 through light amount detection, a countermeasure against a picture quality failure such as a screen burn can be taken by the light detection driver 22 supplying detection information to the signal correction portion 11a of the horizontal selector 11.

### 3-5. Light Detection Operation Period

Here, the period of executing the light detection operation for carrying out the above-described light detection operation is described.

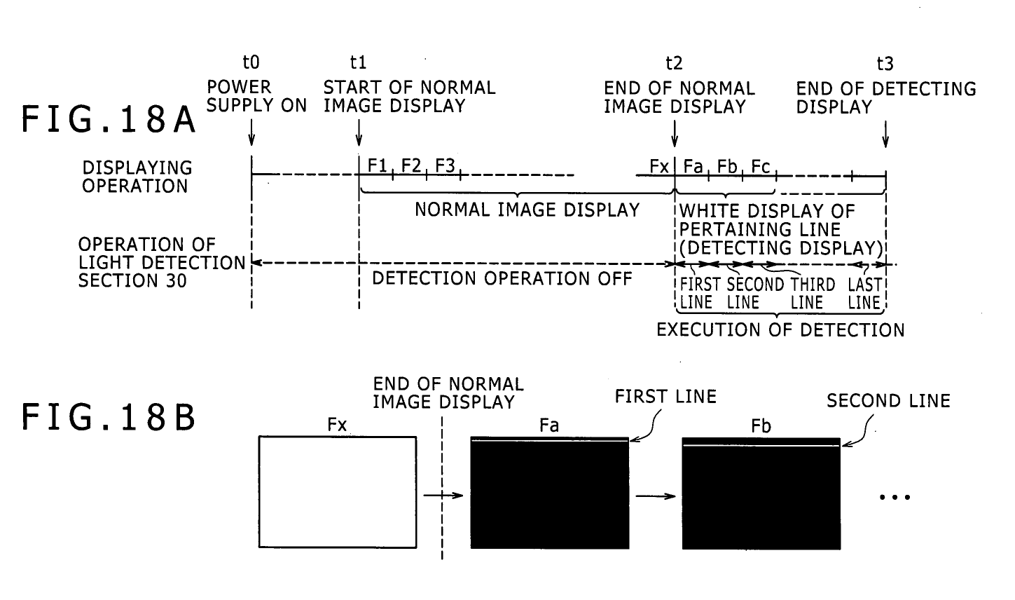

FIG. 18A illustrates a light detection operation carried out after a normal image display.

It is to be noted that the term “normal image display” used hereinbelow signifies a state wherein a signal value Vsig based on an image signal supplied to the display apparatus is provided to each pixel circuit 10 to carry out an image display of an ordinary dynamic image or still image.

It is assumed that, in FIG. 18A, the power supply to the display apparatus is turned on at time to.

Here, various initialization operations upon turning on of the power supply are carried out before time t1, and a normal image display is started at time t1. Then, after time t1, a display of frames F1, F2, . . . of video images is executed as the normal image display.

In this period, the light detection section 30 does not execute a light detection operation.

At time t2, the normal image display ends. This corresponds to such a case that, for example, a turning off operation for the power supply is carried out.

In the example of FIG. 18A, the light detection section 30 executes a light detection operation after time t2.

In this instance, the light detection operation is carried out for pixels for one line, for example, within a period of one frame.

For example, when the light detection operation is started, the horizontal selector 11 causes the pixel circuits 10 within a first frame Fa to execute such a display that the first line is displayed by a white display as seen in FIG. 18B. In short, the signal value Vsig is applied to the pixel circuits 10 such that the pixel circuits 10 in the first line carry out a white display, that is, a high luminance gradation display while all of the other pixel circuits 10 execute a black display.

Within the period of the frame Fa, the light detection sections 30 corresponding to the pixels in the first line detect the emitted light amount of the corresponding pixels. The light detection driver 22 carries out voltage detection of the light detection lines DETL of the columns to obtain emitted light luminance information of the pixels in the first line. Then, the emitted light luminance information is fed back to the horizontal selector 11.

In the next frame Fb, the horizontal selector 11 causes the pixel circuits 10 to execute such a display that a white display is executed in the second line as seen in FIG. 18B. In other words, the horizontal selector 11 causes the pixel circuits 10 in the second line to execute a white display, that is, a high luminance gradation display but causes all of the other pixel circuits 10 to execute a black display.

Within the period of the frame Fb, the pixel circuit 10 corresponding to the pixels in the second line detect the emitted light amount of itself and the corresponding the other pixel circuits. The light detection driver 22 carries out voltage detection of the light detection lines DETL of the columns to obtain emitted light luminance information of the pixels in the second line. Then, the emitted light luminance information is fed back to the horizontal selector 11.

Such a sequence of operations as described above is repeated up to the last line. At a stage wherein emitted light luminance information of the pixels of the last line is detected and fed back to the horizontal selector 11, the light detection operation ends.

The horizontal selector 11 carries out a signal value correction process based on the emitted light luminance information of the pixels.

When the light detection operation described above is completed at time t3, required processes such as, for example, to switch off the power supply to the display apparatus are carried out.

In the light detection operation examples A and C described above, such light detection operation can be carried out.

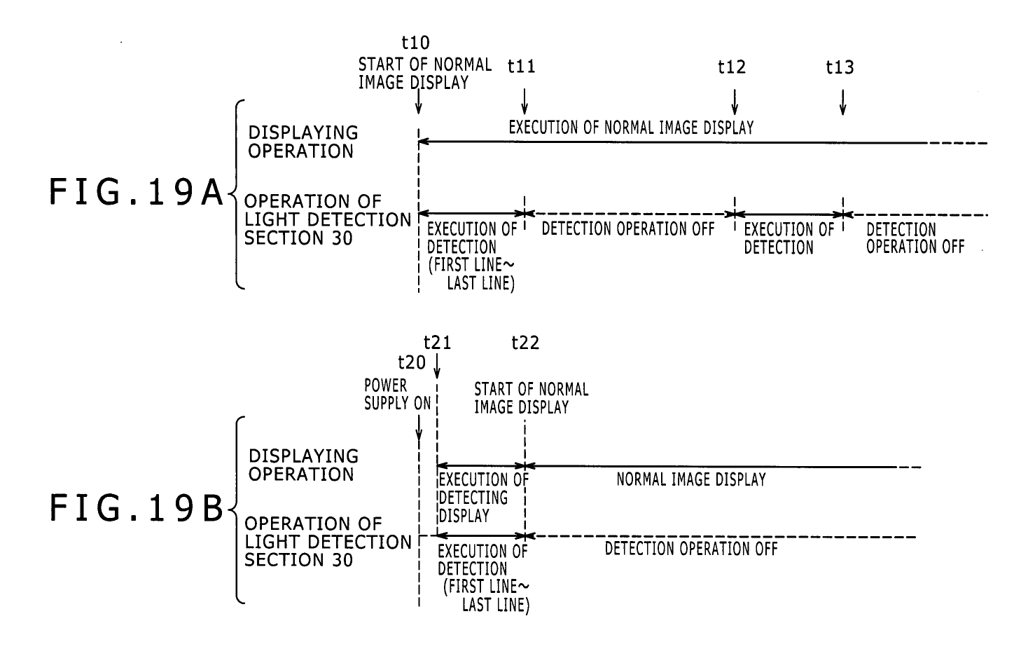

Next, FIG. 19A illustrates a light detection operation carried out in a certain period during execution of the normal image display.

It is assumed that the normal image display is started, for example, at time t10. After the normal image display is started, the light detection operation by the light detection sections 30 is carried out for one line within a period of one frame. In other words, a detection operation similar to that carried out within the period from time t2 to time t3 of FIG. 18A is carried out. However, the display of each pixel circuit 10 is an image display in an ordinary case but is not a display for a light detection operation as in FIG. 18B.

When the light detection operation ends for the first to the last lines, the light detection operation is ended once.

The light detection operation is carried out after every predetermined period, and if it is assumed that the timing of a detection operation period comes at certain time t12, then a light detection operation from the first to the last line is carried out similarly. Then, after the light detection operation is completed, no light detection operation is carried out within a predetermined period of time.

For example, during execution of the normal image display, the light detection operation may be carried out in parallel in a predetermined period.

FIG. 19B illustrates a light detection operation carried out when the power supply is turned on.

It is assumed that the power supply to the display apparatus is turned on at time t20. Here, immediately after various initialization operations such as starting up when the power supply is made available are carried out, a light detection operation is carried out from time t21. In particular, a detection operation similar to the operation carried out within the period from time t2 to time t3 of FIG. 18A is carried out. Also each pixel circuit 10 executes a display for a light detection operation for displaying one line by a white display for every one frame while carrying out the light detection as shown in FIG. 18B.

After the light detection operation for the first to the last lines is completed, the horizontal selector 11 causes the pixel circuits 10 to start the normal image display at time t22. In the above-described light detection operation examples A and C, such light detection operation can be carried out.

For example, if the light detection operation is carried out after the normal image display comes to an end, during execution of the normal image display, before ordinary image display is started or at some other timing as described above and then the signal value correction process based on the detection is carried out, degradation of the emitted light luminance can be coped with.

It is to be noted that the light detection operation may be carried out, for example, at both timings after the normal image display ends and before the ordinary image display is started.

Where the light detection operation is carried out at both or one of the timings after the normal image display ends and before the ordinary image display is started, since such a display for the light detection operation as illustrated in FIG. 18B can be carried out, there is an advantage that the detection can be carried out with emitted light of a high gradation as in the case of the white display. Also it is possible for a display of an arbitrary gradation to be executed to detect a degree of degradation for each gradation.

On the other hand, where the light detection operation is carried out during execution of the normal image display, since the substance of an image being displayed actually is indefinite, it is not possible to specify a gradation to carry out the light detection operation. Therefore, it is necessary to decide a detection value as a value determined taking an emitted light gradation, that is, the signal value Vsig applied then to a pixel of the object of detection into consideration and carry out a signal value correction process. It is to be noted that, since a light detection operation and a correction process can be carried out repetitively during execution of the normal image display, there is an advantage that luminance degradation of the organic EL elements 1 can be coped with substantially normally.

Further, in the light detection operation example B, since light detection is carried out by a neighboring pixel in the same row, such display as in FIGS. 18A and 18B and 19A and 19B is difficult if the light detection operation example B is applied as it is.

However, for example, after ordinary image display comes to an end or before ordinary image display is started, a light detection operation can be carried out.

First, within a period of one frame, the pixel circuits 10 in the odd-numbered columns carry out light emission and the pixel circuits 10 in the even-numbered columns carry out light detection.

Within a period of a next one frame, the pixel circuits 10 in the even-numbered columns carry out light emission and the pixel circuits 10 in the odd-numbered columns carry out light detection.

By repeating such operations as described above, light detection by a neighboring pixel circuit 10 can be carried out with regard to all pixel circuits 10.

It is to be noted that the various light detection operation examples described above can be applied also to the second and other embodiments described below.

### 4. Second Embodiment

### 4-1. Circuit Configuration

Now, a second embodiment of the present invention is described.

The second embodiment is an example wherein a pixel circuit 10 is configured such that it can carry out correction of the threshold voltage and the mobility of the driving transistor Td.

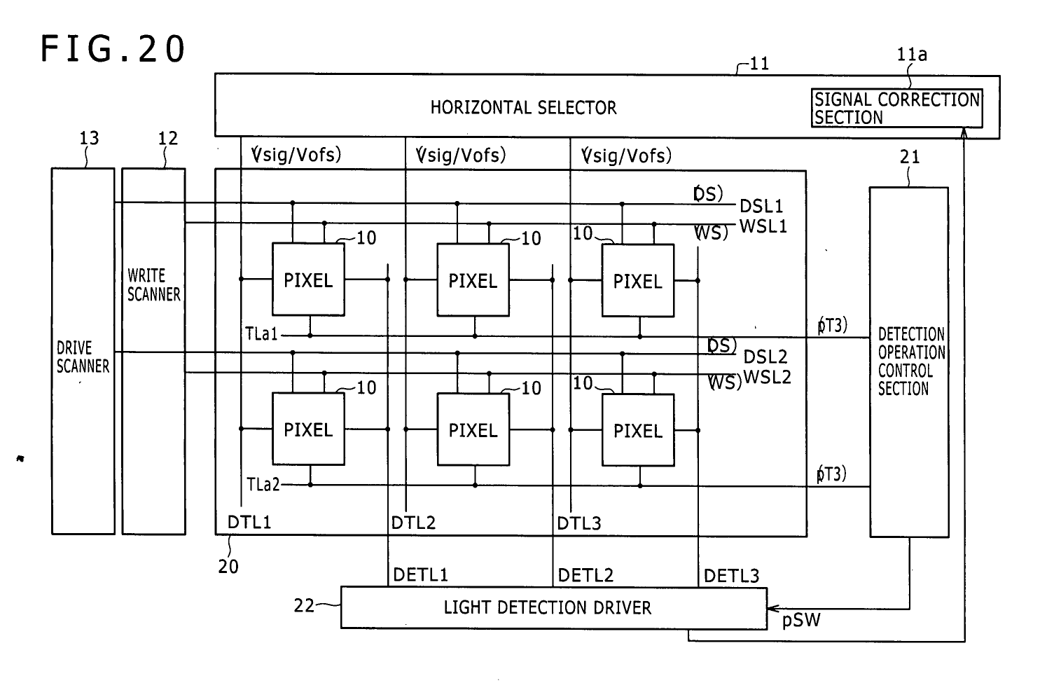

In the present second embodiment, an organic EL display apparatus has such a configuration as shown in FIG. 20. The organic EL display apparatus is similar in configuration to the organic EL display apparatus in the first embodiment, and the following description is given of differences between them while overlapping description of common configurations is omitted herein to avoid redundancy.

Referring to FIG. 20, the organic EL display apparatus includes a drive scanner 13 in addition to the horizontal selector 11 and the write scanner 12 in order to carry out light emission driving of the pixel circuits 10.

Further, on the pixel array 20, power supply control lines DSL1, DSL2, . . . are disposed in the direction of a row in addition to the writing control lines WSL1, WSL2, . . . . The numbers of the writing control lines WSL and the power supply control lines DSL are equal to the number of rows of the pixel circuits 10 disposed in a matrix on the pixel array 20.

Similarly as in the organic EL display apparatus of FIG. 1, the writing control lines WSL, that is, WSL1, WSL2, . . . , are driven by the write scanner 12. The write scanner 12 successively supplies a scanning pulse WS to the writing control lines WSL1, WSL2, disposed in rows at predetermined timings set in advance to line-sequentially scan the pixel circuit 10 in a unit of a row.

The power supply control lines DSL, that is, DSL1, DSL2, . . . , are driven by the drive scanner 13. The drive scanner 13 supplies a power supply pulse DS to the power supply control lines DSL1, DSL2, . . . disposed in rows in synchronism with the line-sequential scanning by the write scanner 12. The power supply pulse DS has a power supply potential which changes over between two values of a driving potential, that is, Vcc, and an initial potential, that is, Vss.

The horizontal selector 11 supplies a signal value potential, that is, Vsig, and a reference value potential, that is, Vofs, as input signals to the pixel circuits 10 to the signal lines DTL1, DTL2, . . . disposed in the direction of a column in synchronism with the line-sequential scanning by the write scanner 12.

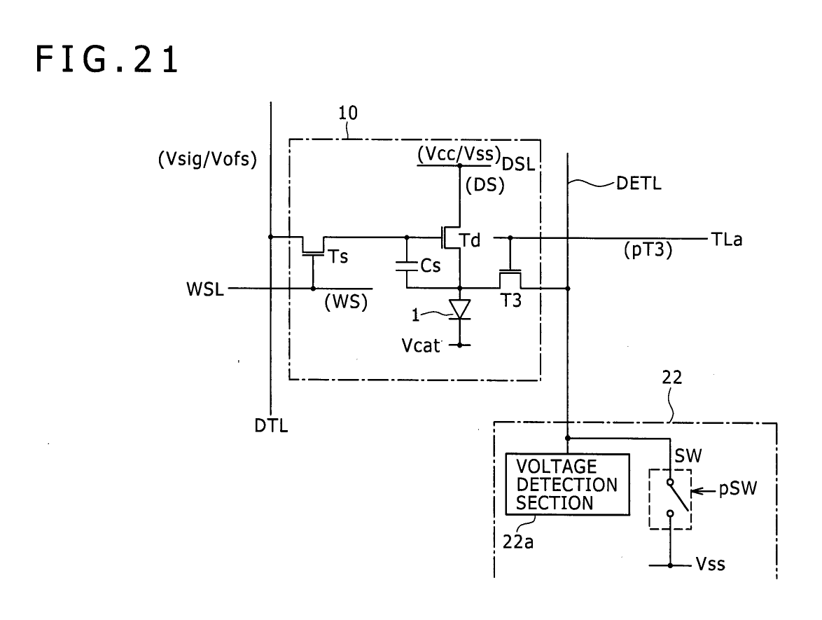

FIG. 21 shows an example of a configuration of a pixel circuit 10 in the second embodiment. Such pixel circuits 10 are disposed in a matrix like the pixel circuits 10 in the configuration of FIG. 20.

Referring to FIG. 21, the pixel circuit 10 includes an organic EL element 1 which is a light emitting element, one holding capacitor Cs, and thin-film transistors, that is, n-channel TFTs, as a sampling transistor Ts, a driving transistor Td and a switching transistor T3.

The holding capacitor Cs is connected at one of terminals thereof to the source of the driving transistor Td and at the other terminal thereof to the gate of the driving transistor Td.

The light emitting element of the pixel circuit 10 is the organic EL element 1, for example, of the diode structure and is connected at the anode thereof to the source of the driving transistor Td and at the cathode thereof to a predetermined wiring line, that is, to a cathode potential Vcat.

The sampling transistor Ts is connected at one of the drain and the source thereof to the signal line DTL and at the other of the drain and the source thereof to the gate of the driving transistor Td.

Further, the sampling transistor Ts is connected at the gate thereof to the writing control line WSL.

The driving transistor Td is connected at the drain thereof to the power supply control line. DSL.

Light emission driving of the organic EL element 1 is basically carried out in the following manner.

At a timing at which the signal potential Vsig is applied to the signal line DTL, the sampling transistor Ts is rendered conducting by a scanning pulse WS applied from the write scanner 13 through the writing control line WSL. Consequently, the input signal Vsig from the signal line DTL is written into the holding capacitor Cs.

The driving transistor Td supplies current Ids in accordance with the signal potential held in the holding capacitor Cs to the organic EL element 1 in response to supply of current from the power supply control line DSL to which the driving potential Vcc is applied by the drive scanner 12 so that the organic EL element 1 emits light.

In short, although, within each frame period, an operation of writing a signal value Vsig which is a gradation value into the holding capacitor Cs of the pixel circuit 10 is carried out, this determines the gate-source voltage Vgs of the driving transistor Td in response to a gradation to be displayed.

When the driving transistor Td operates in a saturation region, it functions as a fixed current source for the organic EL element 1 and supplies current in accordance with the gate-source voltage Vgs to the organic EL element 1. Consequently, the organic EL element 1 carries out emission of light of a luminance in accordance with the gradation value.

Each pixel circuit 10 can carry out a threshold value correction operation and a mobility correction operation for compensating for deterioration of the uniformity caused by a dispersion in threshold value and mobility of the driving transistor Td of the pixel circuit 10.

Although a threshold value correction operation and a mobility correction operation themselves are available in related arts, the necessity for them is described below simply.

For example, in a pixel circuit which uses polycrystalline silicon TFTs or the like, the threshold voltage Vth of the driving transistor Td or the mobility p of a semiconductor thin film which configures the channel of the driving transistor Td sometimes exhibits a time-dependent variation. Further, a dispersion of the fabrication process sometimes causes the transistor characteristic of the threshold voltage Vth or the mobility μ to be different among different pixels.

If the threshold voltage or the mobility of the driving transistor Td is different among different pixels, then a dispersion appears with the value of current flowing to the driving transistor Td for each pixel. Therefore, even if an equal signal value of the image signal value (signal value Vsig) is applied to all pixel circuits 10, a dispersion in luminance of emitted light of the organic EL element 1 appears for each pixel. As a result, the uniformity of the screen is damaged.

From this, in a pixel circuit operation, a correction function for the threshold voltage Vth and the mobility μ is provided.

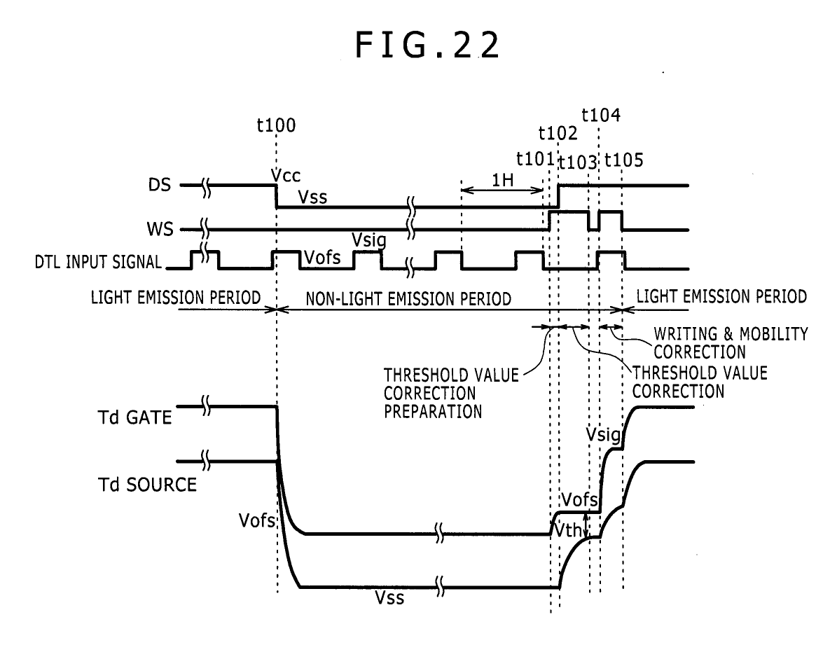

Here, prior to description of the light detection operation, an example of a light emitting operation which involves threshold value correction and mobility correction is described with reference to FIG. 22. It is assumed here that, in the operation given below with reference to FIG. 22, the switching transistor T3 is ignored or is in an off state.

In FIG. 22, as light emitting operation waveforms of a pixel circuit 10, the power supply pulse DS, scanning pulse WS, input signal of the signal line DTL, and a gate voltage variation and a source voltage variation of the driving transistor Td are illustrated.

First, at time t100 at which a light emission period of a preceding frame comes to an end, the drive scanner 13 applies the initial potential Vss as the power supply pulse DS of the power supply control line DSL to initialize the source potential of the driving transistor Td.

Then, at time t101 at which the reference value potential Vofs is applied to the signal line DTL from the horizontal selector 11, the write scanner 12 renders the sampling transistor Ts conducting to fix the gate potential of the driving transistor Td to the reference value potential Vofs.

In this state, the drive scanner 13 applies the power supply potential Vcc to the driving transistor Td from the drive scanner 13 so that the threshold voltage Vth of the driving transistor Td is held into the holding capacitor Cs within a period from time t102 to time t103. In other words, a threshold value correction operation is carried out.

Thereafter, within a period within which a signal value potential is applied to the signal line DTL from the horizontal selector 11, that is, within a period from time t104 to time t105, the sampling transistor Ts is rendered conducting to write the signal value into the holding capacitor Cs under the control of the write scanner 12. At this time, also mobility correction of the driving transistor Td is carried out.

Thereafter, current corresponding to the signal value written in the holding capacitor Cs flows to the organic EL element 1 to carry out light emission of a luminance in accordance with the signal value.

By this operation, the influence of the dispersion in threshold value and mobility of the driving transistor Td is canceled.

### 4-2. Light Detection Operation

A light detection operation example in the second embodiment will be described.

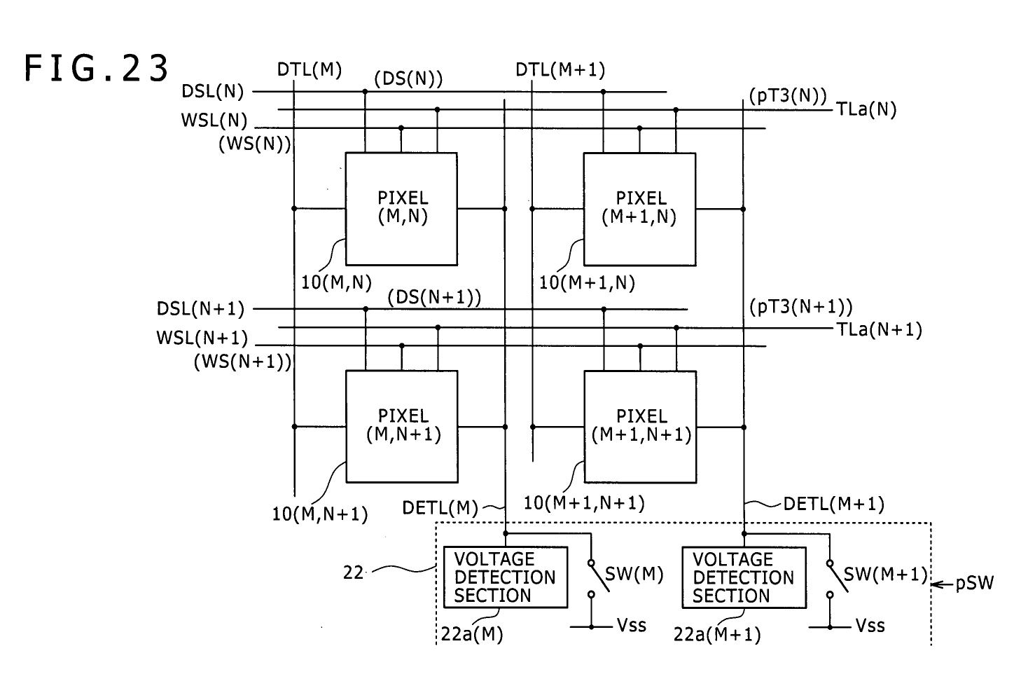

For the convenience of description, reference characters of FIG. 23 are used. FIG. 23 shows certain four pixel circuits 10(M, N), 10(M+1, N), 10(M, N+1) and 10(M+1, N+1).

As regards the signal lines DTL and the light detection lines DETL, similarly as FIG. 1, the signal lines and the light detection lines for the Mth column and the M+1th column are denoted by DTL(M), DTL(M+1), DETL(M), and DETL(M) and the signal line for the M+1th column is denoted by DTL(M+1). Also the voltage detection sections 22a and the switches SW in the light detection driver 22 are identified with M and M+1 applied thereto.

As regards the power supply control lines DSL, the power supply control lines DSL for the Nth line is denoted by DSL(N) and the power supply control lines DSL for the N+1th line is denoted by DSL(N+1). Also, the power supply pulses on the power supply control lines DSL(N) and DSL(N+1) are denoted by DS(N) and DS(N+1), respectively.

As regards the writing control lines WSL, similarly as FIG. 11, the writing control lines WSL are denoted by WSL(N), WSL(N+1), and the scanning pulses are denoted by WS(N) and WS(N+1).

Also the control lines TLa are denoted by TLa(N) and TLa(N+1) similarly, and also the control pulses are denoted by pT3(N) and pT3(N+1).

Further, reference characters Ts, Td, T3, Cs and 1 of the elements in the pixel circuit 10 may be sometimes denoted by “(M, N),” “(M+1, N)” and so forth.

Subsequently, as a light detection operation example, a leftwardly or rightwardly neighboring emitted light detection operation of detecting emitted light from the pixel circuit 10(M, N) by means of the pixel circuit 10(M+1, N) in the same row is described.

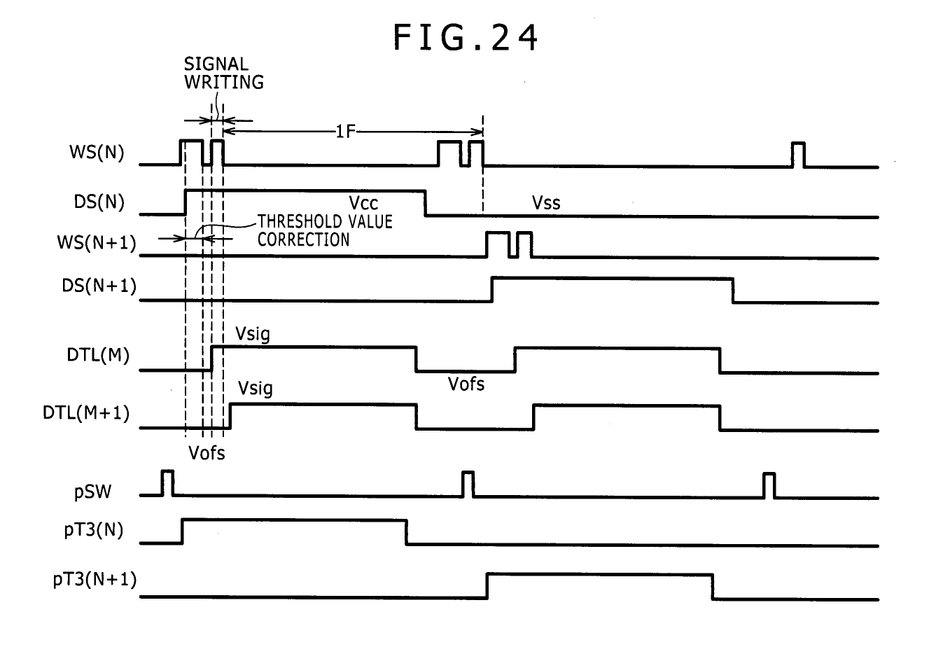

FIG. 24 illustrates a scanning pulse WS(N) applied to the writing control line WSL(N) of the Nth row from the write scanner 12 and a scanning pulse WS(N+1) applied to the writing control line WSL(N+1) of the N+1th row from the write scanner 12.

FIG. 24 also illustrates a power supply pulse DS(N) applied to the power supply control lines DSL(N) of the Nth row from the drive scanner 13 and a power supply pulse DS(N+1) applied to the power supply control lines DSL(N+1) of the N+1th row.

FIG. 24 further illustrates signal values applied to the signal lines DTL(M) and DTL(M+1) from the horizontal selector 11.

FIG. 24 further illustrates a control signal pSW from the detection operation control section 21 for controlling the switch SW in the light detection driver 22 between on and off. Furthermore, FIG. 24 illustrates a control pulse pT3(N) applied to the control line TLa(N) of the Nth row from the detection operation control section 21 and a control pulse pT3(N+1) to be applied to the control line TLa(N+1) of the N+1th row from the detection operation control section 21.

It is assumed that light detection is carried out once within a period of one frame.

In this instance, the pixel circuit 10(M, N) executes light emission and the emitted light amount of the pixel circuit 10(M, N) is detected by the pixel circuit 10(M+1, N).

The horizontal selector 11 applies a signal value VsigH and a reference value potential Vofs at predetermined timings to the signal lines DTL.

To the objects pixel circuits 10(M, N) and 10(M+1, N) in the same row, a scanning pulse WS(N), a power supply pulse DS(N) and a control pulse pT3(N) are applied.

Within a period of a first one frame, light emission by the pixel circuit 10(M, N) and light detection by the pixel circuit 10(M+1, N) are carried out with the pulses just mentioned and the potentials of the signal lines DTL(M) and DTL(M+1).

Within a period of a next one frame, light emission and light detection in the next row are carried out with the scanning pulse WS(N+1), power supply pulse DS(N+1), control pulse pT3(N+1) and potentials of the signal lines DTL(M) and DTL(M+1). For example, light emission by the pixel circuit 10(M, N+1) and light detection by the pixel circuit 10(M+1, N+1) are carried out.

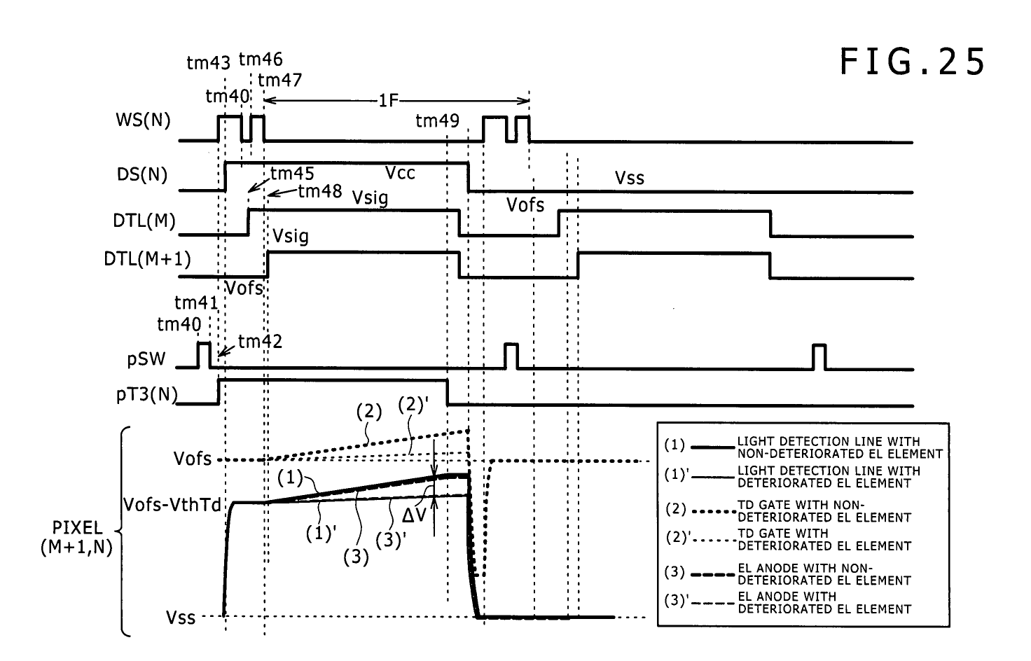

Waveforms within a period of one frame of FIG. 24, that is, within a light detection period by the pixel circuit 10(M+1, N), are shown in FIG. 25.

FIG. 25 particularly illustrates the scanning pulse WS(N), power supply pulse DS(N), control signal pSW, control pulse pT3(N) and voltages applied to the signal lines DTL(M) and DTL(M+1).

Further, while FIG. 25 shows waveforms (1), (1)′, (2), (2)′, (3) and (3)′ similarly to FIGS. 13, 15 and so forth, they indicate potential variations of the pertaining portions on the pixel circuit 10(M+1, N) in the case of light reception from the pixel circuit 10(M, N), that is, light reception in accordance with a degree of degradation of the organic EL element 1(M, N). In particular, the waveforms (1) and (1)′ indicate potentials of the light detection line DETL(M+1) based on the received light amount. The waveforms (2) and (2)′ indicate gate potentials of the driving transistor Td(M+1, N) based on the received light amount. The waveforms (3) and (3)′ indicate anode potentials of the organic EL element 1(M+1, N) based on the received light amount.

A light detection operation by the pixel circuit 10(M+1, N) within a period of one frame is such as follows.

In particular, within a period from time tm40 to time tm41, the switch SW(M+1) is turned on with the control signal pSW to charge the light detection line DETL(M+1) to the potential Vss.

At tm43, the power supply pulse DS(N) is set to the power supply voltage Vcc.

Also, from tm42 to tm43, the scanning pulse WS is set to the H level. At this time, the signal lines DTL(M) and DTL(M+1) are set to the reference value potential Vofs, respectively.

In the pixel circuit 10(M, N) on the light emission side, threshold value correction operation preparations within a period from time tm42 to time tm43 and a threshold value correction operation within a period from time tm43 to time tm44 are carried out before light emission. This corresponds to operation within the period from time t101 to time t102 and within the period from time t102 to time t103 of FIG. 22.

In particular, within the period from time tm42 to time tm43, the gate potential of the driving transistor Td(M, N) is set to the reference potential Vofs and the source potential is set to the initial potential Vss to sufficiently widen the gate-source voltage of the driving transistor Td(M, N). Then within a period from time tm43 to time tm44, the power supply potential Vcc is applied so that the gate-source voltage Vgs of the driving transistor Td(M, N) becomes equal to the threshold voltage of the driving transistor Td(M, N).

Thereafter, in the pixel circuit 10(M, N), the sampling transistor Ts(M, N) is turned on with the scanning pulse WS(N) within a period from time tm46 to time tm47. However, at this time, since the signal value Vsig is applied to the signal line DTL(M), the signal value Vsig is written into the gate of the driving transistor Td(M, N). Then, mobility correction and light emission are carried out.

On the other hand, in the pixel circuit 10(M+1, N) which carries out a light detection operation, the reference potential Vofs is written into the gate of the driving transistor Td and the source voltage of the driving transistor Td(M+1, N) is set to the initial potential Vss similarly as in the case within the period from time tm42 to time tm43.

It is to be noted that, since the switching transistor T3 is turned on with the control pulse pT3(N) at time tm42, the source voltage of the driving transistor Td(M+1, N) is equal to the initial potential Vss.

Then, since the power supply potential Vcc is applied within the period from time tm43 to time tm44, threshold value correction is carried out so that the gate-source voltage Vgs of the switching transistor T3 becomes equal to the threshold voltage of the driving transistor Td(M+1, N). As seen in FIG. 22, the anode potential of the organic EL element 1(M+1, N) which is equal to the source potential of the driving transistor Td(M+1, N) becomes equal to Vofs−VthTd where the VthTd is the threshold voltage of the driving transistor Td. This similarly applies also to the potential of the light detection line DETL(M+1).

Thereafter, in the pixel circuit 10(M+1, N), the sampling transistor Ts(M, N) is turned on with the scanning pulse WS(N) within a period from time tm46 to time tm47. However, at this time, the potential of the signal line DTL(M+1) remains equal to the reference potential Vofs. Accordingly, the potential of the gate of the driving transistor Td(M+1, N) remains equal to the reference potential Vofs and no light emitting operation is carried out.

At time tm48 after the level of the scanning pulse WS(N) is changed to the L level at time tm47, the horizontal selector 11 changes the potential of the signal line DTL(M+1) from the reference value potential Vofs to the signal value Vsig. Here, the signal value Vsig is the potential of the white display, and although this is preferable, the signal value Vsig is not necessarily limited to the white potential.

By the operation described, a potential difference of VsigH−VsigL appears between the source and the drain of the sampling transistor Ts(M+1, N), that is, between the gate potential of the driving transistor Td(M+1, N) and the potential of the signal line DTL(M+1).

Further, since the adjacent pixel circuit 10(M, N) emits light as described above, the leak amount of the sampling transistor Ts(M+1, N) which operates as a light detection element varies in response to light incident to the cannel of the sampling transistor Ts(M+1, N).

As seen in FIG. 25, the gate potential of the driving transistor Td(M+1, N) undergoes a variation by an influence of the leak current after time tm48.

Specifically, if the brightness of light incident to the sampling transistor Ts(M+1, N) is high, then the leak current is high and the variation amount of the gate potential of the driving transistor Td(M+1, N) is great. On the other hand, if the brightness of the light is low, then the leak current is low and the variation amount of the gate potential of the driving transistor Td(M+1, N) is small (refer to the waveforms (2) and (2)′ of FIG. 25).

Also the source potential of the driving transistor Td(M+1, N), and hence the anode potential of the organic EL element 1(M+1, N), and the potential of the light detection line DETL(M+1) vary in an interlocking relationship with the variation of the gate potential of the driving transistor Td(M+1, N) (refer to the waveforms (1), (3), (1)′ and (3)′ of FIG. 25. That is to say, the anode potential of the organic EL element 1(M+1, N), and the potential of the light detection line DETL(M+1) vary from Vofs−VthTd.

Consequently, after lapse of a fixed period of time, the potential of the light detection line DETL(M+1) exhibits a difference ΔV depending upon whether or not the organic EL element 1(M, N) of the adjacent pixel circuit 10(M, N) suffers from deterioration. The resulting difference ΔV is detected by the voltage detection section 22a (M+1).

In this manner, the leftwardly or rightwardly neighboring emitted light detection operation of detecting emitted light from the pixel circuit 10(M, N) by means of the pixel circuit 10(M+1, N) in the same row is carried out.

Finally at time tm49, the switching transistor T3(M+1, N) is turned off, whereafter the signal line potential is varied to the reference potential Vofs and then the scanning pulse WS(N) is varied to the initial potential Vss. Then, the sampling transistor Ts(M+1, N) is turned on with the scanning pulse WS(N) to initialize the gate potential and the source potential of the driving transistor Td(M+1, N). Although it is preferable to carry out the initialization operation which is carried out by turning on the sampling transistor Ts(M+1, N), it does not have to necessarily be carried out.

In this manner, also a pixel circuit 10 wherein threshold voltage correction and mobility correction of the driving transistor Td can be carried out can execute light detection using the sampling transistor Ts therein as a light sensor.

Consequently, similarly as in the first embodiment, enhancement in yield can be implemented using a small number of elements, and a countermeasure against a failure in picture quality such as a screen burn can be taken.

It is to be noted that, while the example described above in the description of the second embodiment corresponds to the light detection operation example B of the first embodiment, also the organic EL display apparatus of the present second embodiment can similarly carry out operations corresponding to the light detection operation examples A and C, that is, self emitted light detection and upwardly or downwardly neighboring emitted light detection.

### 4-3. Modifications to the Second Embodiment

Incidentally, while the pixel circuit 10 in the second embodiment described above carries out threshold value correction and mobility correction, the following modification is possible as an example which can carry out such a light emitting operation of the pixel circuit 10 as illustrated in FIG. 22.

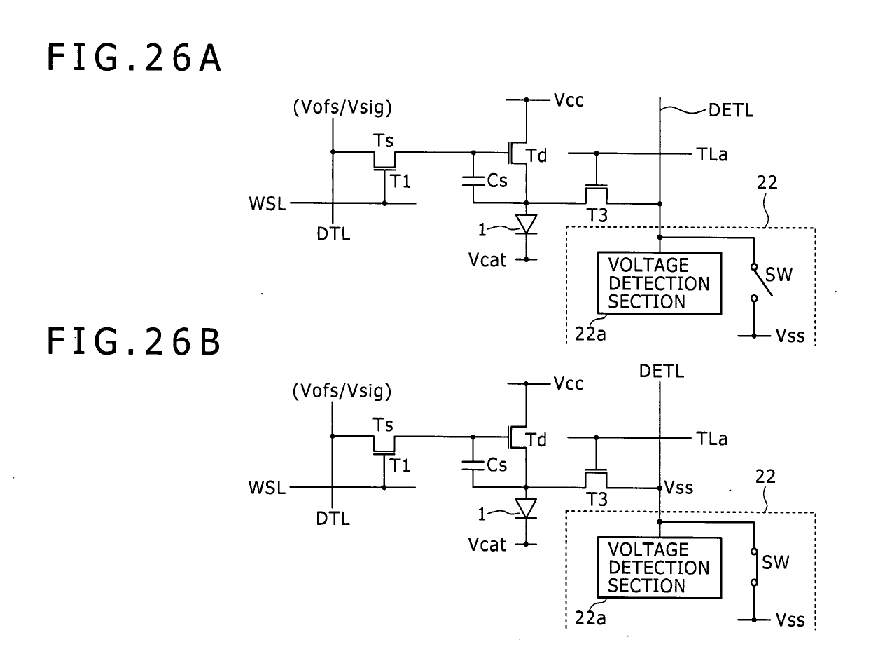

FIG. 26A shows a modification wherein the power supply control line DSL is used as a fixed power supply line merely for the power supply potential Vcc. The driving transistor Td is connected at the drain thereof to the power supply potential Vcc which is a fixed power supply. Except this, the modified pixel circuit 10 is similar to that of the pixel circuit 10 described hereinabove with reference to FIG. 21.

As described hereinabove with reference to FIG. 22, upon a threshold value correction operation, the source of the driving transistor Td is set to the initial potential Vss for preparations for correction.

Here, in the case of the second embodiment, the light detection line DETL can be charged to the initial potential Vss through the switch SW. Accordingly, it is possible to utilize this to make preparations for the threshold value correction operation.

For example, at time t100 of FIG. 22, the switch SW is turned on as seen in FIG. 26B to charge the light detection line DETL to the initial potential Vss. Then, the switching transistor T3 is turned on. By this, the source of the driving transistor Td can be set to the initial potential Vss. There is no necessity to supply a pulse voltage through the power supply control line DSL.

By the measures described, the configuration of the power supply control line DSL and the drive scanner 13 can be replaced by a mere fixed power supply line, and consequently, the configuration of the display apparatus can be simplified.

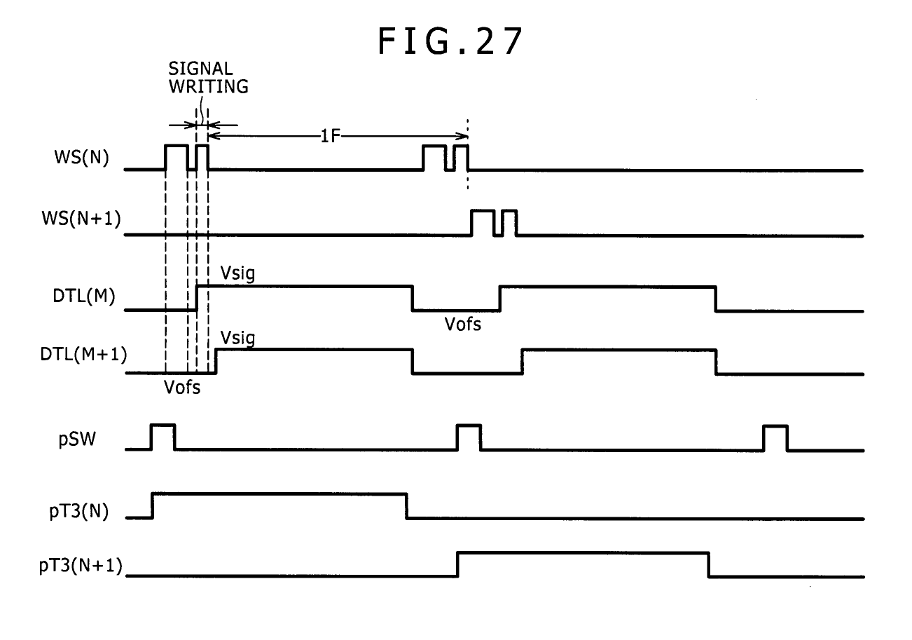

Operation upon light detection is carried out in such a manner as illustrated in FIG. 27. The operation is basically similar to that described hereinabove with reference to FIG. 24, and therefore, overlapping description of the operation is omitted herein to avoid redundancy. It is to be noted, however, that, in the operation illustrated in FIG. 27, the power supply pulse DS is not used.

By adopting such a configuration as described above, light detection can be carried out without increasing the number of elements very much.

### 5. Third Embodiment

A third embodiment of the present invention is described. While, in the first and second embodiments described above, light emission of a pixel circuit 10 is detected by the pixel circuit 10 itself or by a different pixel circuit 10, another case is described here in which light incident from the outside is detected. In particular, this is an example as an electronic apparatus for carrying out input information by irradiating light from the outside to a screen of a display device.

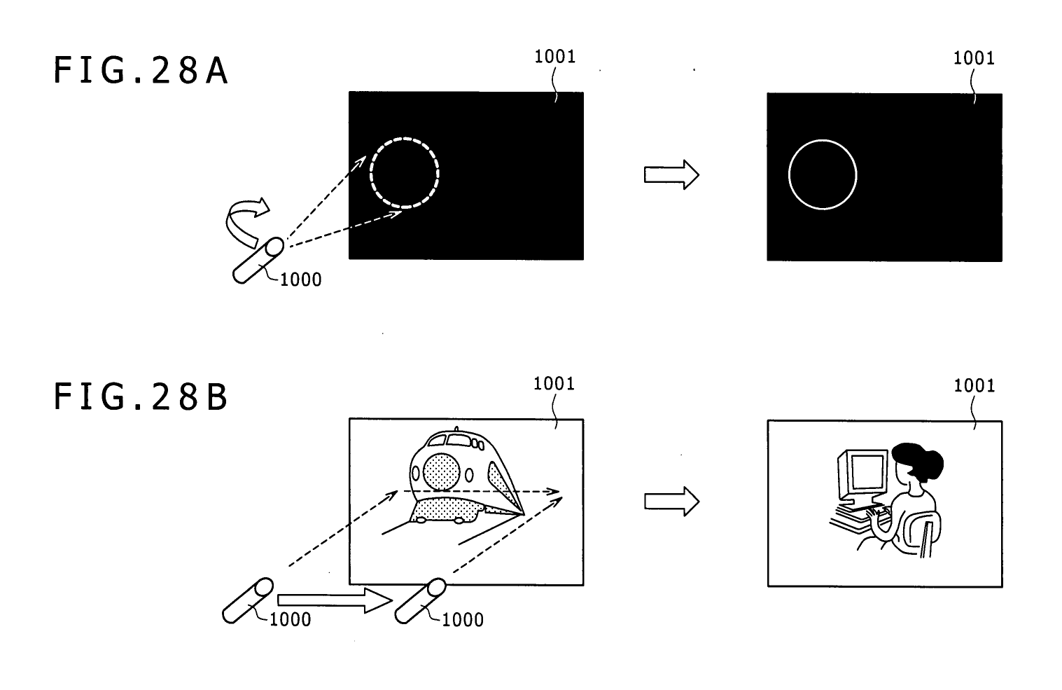

For example, FIG. 28A illustrates a state wherein a user operates a laser pointer 1000 to direct a laser beam to a display panel 1001.

The display panel 1001 may be any of the organic EL display panels described hereinabove with reference to FIGS. 1 and 20.

For example, while the overall screen displays black, a circle is drawn on the display panel 1001 using the light of the laser pointer 1000. Thus, the circle is displayed on the screen of the display panel 1001.

In particular, the light of the laser pointer 1000 is detected by each pixel circuit 10. Then, the light detection driver 22 transmits detection information (information of detection pixels) of the laser light to the horizontal selector 11, particularly to the signal value correction section 11a.

The horizontal selector 11 applies the signal value Vsig of a predetermined luminance to the pixel circuits 10 by which the laser light is detected.

Consequently, light of a high luminance can be generated from the screen of the display panel 1001 at the irradiated position of the laser light. In short, such a display as to draw a graphic figure, a character, a symbol or the like on the panel can be carried out by laser irradiation.

FIG. 28B illustrates an example wherein an input of a direction by the laser pointer 1000 is detected.

Referring to FIG. 36B, a laser beam is irradiated from the laser pointer 1000 such that it moves, for example, from the right to the left. Since the variation of the laser irradiation position on the screen can be detected as a result of detection by each pixel circuit 10 on the display panel 1001, it can be detected in which direction the laser light is directed by the user.

For example, changeover of the display contents or the like is carried out so that this direction may be recognized as an operation input.

Naturally, it is possible to recognize the operation contents by directing the laser beam to an operation icon or the like displayed on the screen.

In this manner, it is possible to recognize light from the outside as a coordinate input on the display panel 1001 so as to be applied to various operations and applications.

Then, the operation described above can be carried out even if the first and second embodiments are utilized as they are. However, the organic EL display apparatus in the first and second embodiments are sometimes ineffective for the operation described where they operate with regard to light received from the outside other than the organic EL elements 1, for example, with regard to light from the laser pointer 1000 or the like.

This is because, in the case of an application which reacts with light of the laser pointer 1000 or the like in this manner, it is necessary for light to be detected in rather short detection time in order to specify information of the position at which light is irradiated or the like. However, since the sampling transistor Ts for inputting a potential of the signal line DTL to the gate of the driving transistor Td is used as a light detection device in the circuit configuration described above, it is necessary to increase the leak amount with respect to light in order to carry out light detection in short time.

However, if the leak amount of light is increased, then there is a case in which, upon normal image display, nonuniformity arising from leak of light of the sampling transistor Ts occurs, resulting in deterioration of the display quality.

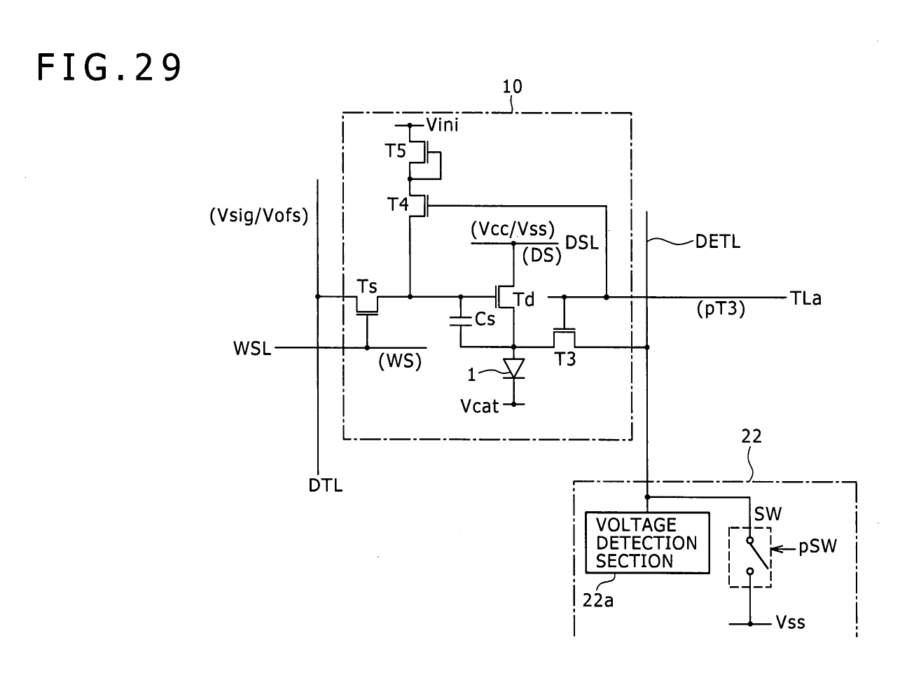

Therefore, for the external light detection described above, a configuration shown in FIG. 29 seems applicable as amore suitable example.

The pixel circuit 10 shown in FIG. 29 includes, similarly to that shown in FIG. 21, a sampling transistor Ts, a driving transistor Td, a switching transistor T3, a holding capacitor Cs and an organic EL element 1.

The pixel circuit 10 shown in FIG. 29 further includes a light detection element T5 and a second switching transistor T4 in addition to the components just described. The light detection element T5 is a transistor connected in diode connection. Naturally, there is no necessity to connect the light detection element T5 in diode connection, but a predetermined voltage may be applied to the gate of the light detection element T5.

The light detection element T5 and the second switching transistor T4 are connected in series between a fixed potential Vini and the gate of the driving transistor Td.

Preferably, the fixed potential Vini is higher upon light detection than the gate potential of the driving transistor Td.

The second switching transistor T4 is connected at the gate thereof to the controlling line TLa. Accordingly, the second switching transistor T4 is switched on/off in accordance with the control pulse pT3 together with the switching transistor T3.

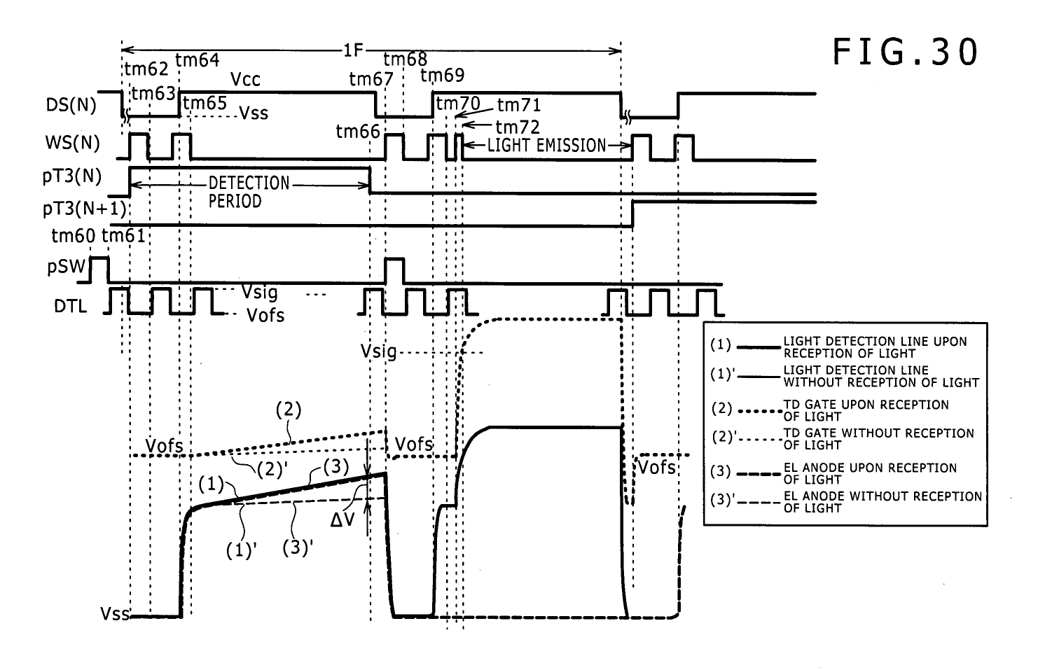

A light detection operation is described with reference to FIG. 30. In FIG. 30, as an example, a light detection operation for one line is carried out within a period of one frame. Further, detection of light irradiated from the outside is carried out within the former half of the one-frame period and light emission of the pixel circuit 10 itself is carried out within the latter half of the one-frame period. FIG. 30 illustrates a power supply pulse DS(N), a scanning pulse WS(N), control pulses pT3(N) and pT3(N+1), a control signal pSW and a voltage to be applied to the signal line DTL(M), that is, a signal value Vsig or a reference potential Vofs.

Further, waveforms (1), (1)′, (2), (2)′, (3) and (3)′ are indicated similarly as in FIGS. 13, 15 and so forth. The waveforms just mentioned indicate a potential variation of the pertaining portions regarding the pixel circuit 10(M, N) itself. However, since light detection targets incident light from the outside, the waveforms are indicated in regard to whether or not light is received.

It is to be noted that, since the following description is given of one pixel circuit 10 in an Nth row, the reference characters used in FIG. 29 are used and a suffix such as [(M, N)] is not applied to the reference characters of the components.

Within a period from time tm60 to time tm61, the switch SW is placed in an on state with the control signal pSW to charge the light detection line DETL to the potential Vss.

Within a period from time tm62 to time tm63, the scanning pulse WS (N) is set to the H level to turn on the sampling transistor Ts. At this time, since the reference potential Vofs is applied to the signal line DTL, the potential of the gate of the driving transistor Td becomes equal to the reference potential Vofs.

Further, the switching transistor T3 is turned on to connect the source of the driving transistor Td to the light detection line DETL, and also the potential of the power supply pulse DS (N) is set to the initial potential Vss. Therefore, the potential of the source of the driving transistor Td and hence of the anode of the organic EL element 1 and the light detection line DETL is set to the initial potential Vss.

Thereafter, within a period from time tm64 to time tm65, the scanning pulse WS(N) is placed into the H level, and the power supply pulse DS is set to the power supply voltage Vcc in a state wherein the potential of the gate of the driving transistor Td is fixed to the reference potential Vofs of the signal line DTL. Consequently, threshold value correction operation of the driving transistor Td is carried out.

Thereafter, the gate potential of the driving transistor Td comes to vary depending upon whether or not light is received, that is, whether or not leak current of the light detection element T5 exists.

In particular, if light is incident to the light detection element T5, then high leak current appears in response to the light amount, and this increases the variation amount of the gate potential of the driving transistor Td. On the contrary, if there exists no incident light, then the leak amount is small or zero, and this decreases the variation amount of the gate potential of the driving transistor Td (refer to the waveforms (2) and (2)′ in FIG. 30).

Also the source potential of the driving transistor Td and hence the anode potential of the organic EL element 1 and the potential of the light detection line DETL vary in response to the variation of the gate potential of the driving transistor Td (refer to waveforms (1), (3) and (1)′ and (3)′ in FIG. 30).

As a result, after lapse of a fixed period of time, a difference ΔV appears with the potential of the light detection line DETL depending upon whether or not incident light from the outside exists, and the difference is detected by the voltage detection section 22a.

In this manner, the light detection operation of incident light from the outside is carried out by the pixel circuit 10.

The light detection period is ended at time tm66 when the switching transistors T3 and T4 are turned off with the control pulse pT3.

Then, a light emission operation is entered. Within the period of the light emission operation, the light detection element T5 is disconnected from the gate of the driving transistor Td by the second switching transistor T4.

Within a period from time tm67 to time tm68, the scanning pulse WS(N) is set to the H level to turn on the sampling transistor Ts. At this time, since the reference potential Vofs is applied to the signal line DTL, the potential of the gate of the driving transistor Td becomes equal to the reference potential Vofs. Further, the power supply pulse DS is set to the initial potential Vss and the gate potential of the driving transistor Td is set to the initial potential Vss. Consequently, preparations for the threshold value correction operation are made.

Then, within a period from time tm69 to time tm70, the scanning pulse WS(N) is set to the H level and the power supply pulse DS is set to the power supply voltage Vcc in a state wherein the gate of the driving transistor Td is fixed to the reference potential Vofs of the signal line DTL. Consequently, the threshold value correction operation of the driving transistor Td is carried out.

Thereafter, within a period from time tm71 to time tm72, the scanning pulse WS(N) is set to the H level. At this time, the signal value Vsig is applied to the signal line DTL and the signal value Vsig is written into the gate of the driving transistor Td. Then, mobility correction is carried out together with the signal value writing and the pixel circuit 10 is placed into a light emitting state.

In such an operation example as described above, the timing at which the potential of the power supply control line DSL varies from the initial potential Vss to the power supply voltage Vcc exists twice within one frame, and the threshold value correction operation for raising the source potential is carried out for the gate potential of the driving transistor at the two timings.

The threshold value correction operation carried out just before signal writing, that is, within a period from time tm69 to time tm70, from between the two times of the threshold value correction operation is carried out in order to execute threshold value correction for the driving transistor, and the threshold value correction operation carried out after turning off of the EL element, that is, within a period from time tm64 to time tm65, is carried out in order to detect light from the outside.

In the case of the present configuration, since the light detection element T5 is connected to the gate of the driving transistor Td through the second switching transistor T4, even if light leak current of the light detection element T5 is increased, deterioration of the picture quality upon light emission of the organic EL element 1 does not occur.

It is to be noted that the present embodiment can be applied not only to a case wherein external incident light is detected but also to another case wherein, for example, light emission of the organic EL element 1 of a neighboring pixel is detected. In this instance, also detection upon execution of normal image display illustrated in FIG. 19A can be carried out.

Further, since such applications as illustrated in FIGS. 28A and 28B in most cases do not require a resolution particularly equal to the resolution of the panel, it is considered that a plurality of lines may be operated at the same timing or light detection periods of a plurality of lines may be overlapped with each other. Consequently, since the number of light detection devices can be increased, it is possible to increase the light detection accuracy and further shorten the light detection period.

### 6. Modification

While the first to third embodiments are described above, modifications which can be applied to the embodiments are described here.

First, it is considerable to vary the sensitivity of the sampling transistor Ts (or the light detection element T5) in order to fix the voltage level to be outputted to the light detection line DETL from the pixel circuit 10 which detects light of a different wavelength.

In particular, the sensitivity of the sampling transistor Ts for detecting light having high energy is set low while the sensitivity of another sampling transistor Ts for detecting light having low energy is set high. As an example, in order to vary the sensitivity of light, the transistor size determined by the channel length or the channel width of a transistor as the sampling transistor Ts or the film thickness of the channel material should be changed.

In particular, taking detection of light which a pixel circuit 10 emit by itself into consideration, the channel film thickness of a sampling transistor Ts of a pixel circuit 10 which emits light having higher energy such as B light is set thin while the channel width of the sampling transistor Ts is set small. Conversely, the channel film thickness of a sampling transistor Ts which detects light having low energy is set thick while the channel width of the sampling transistor Ts is set large.

For example, among the pixel circuit 10 corresponding to a B light pixel, a G light pixel and a R light pixel, the channel film thickness of the sampling transistor Ts for detecting a pixel of B light is set thinnest while the channel film thickness of the sampling transistor Ts for detecting a pixel of R light is set thickest. Or, the channel width of the sampling transistor Ts for detecting a pixel of B light is set smallest while the channel width of the sampling transistor Ts for detecting a pixel of R light is set greatest. Or both countermeasures are applied.

Generally, a light detection element supplies a greater amount of leak current as the wavelength of light to be received thereby becomes shorter, that is, as the energy of light increases. Therefore, by setting the sensitivity of each sampling transistor Ts in response to the wavelength of light to be received, the variation of the gate potential of the driving transistor Td can be made a fixed value independently of the energy of the light to be received. As a result, the voltages to be outputted to the light detection lines DETL can be set to an equal voltage which does not vary depending upon the emitted light wavelength. Consequently, simplification of the light detection driver 22 can be anticipated.

Also it seems a possible idea to use an example wherein light detection by the plural pixel circuits 10 is carried out at the same timing or another example wherein the light detection periods of the plural pixel circuits 10 are temporally overlapped with each other. Since the number of the light detection elements can be increased by adopting such a timing relationship as just described, it is possible to enhance the light detection accuracy and further shorten the light detection period.

For example, light emission by the pixel circuit 10(M, N) in FIG. 11 may be carried out simultaneously or in a temporally overlapping relationship with that by the pixel circuits 10(M+1, N) and 10(M+1, N+1).

Consequently, the detection sensitivity of the voltage detection section 22(M+1) in the light detection line DETL(M+1) can be enhanced.

The present application contains subject matter related to that disclosed in Japanese Priority Patent Application JP 2010-001878 filed in the Japan Patent Office on Jan. 7, 2010 the entire contents of which are hereby incorporated by reference.

While preferred embodiments of the present invention have been described using specific terms, such description is for illustrative purpose only, and it is to be understood that changes and variations may be made without departing from the spirit or scope of the following claims.

What is claimed is:

1. A display apparatus, comprising:
a plurality of pixel circuits disposed in a matrix at positions at which a signal line and a plurality of scanning lines cross with each other;
a displaying driving section adapted to apply a signal value to each of said pixel circuits through the signal line and drive the scanning lines to cause the pixel circuit to carry out light emission with a luminance in accordance with the signal value to carry out image display; and
a light amount information detection section adapted to detect light amount information from an output of each of said pixel circuits to a light detection line disposed for the pixel circuit;
each of said pixel circuits including
a light emitting element,
a driving transistor for carrying out application of current to said light emitting element in response to a signal value voltage inputted thereto,
a sampling transistor for inputting, when said sampling transistor is switched on, the signal value from the signal line to the gate of said driving transistor, and
a switching transistor connected between an end of said driving transistor and the light detection line;
each of said pixel circuits being capable of executing light detection operation of varying the gate potential of said driving transistor in response to a received light amount and outputting the source potential of said driving transistor in accordance with the potential variation to the light detection line through said switching transistor.

2. The display apparatus according to claim 1, wherein said sampling transistor is structured so as to function as a light sensor in an off state thereof, and applies, as the light detection operation, when the sampling transistor is placed in an off state, leak current in response to the received light amount to the gate of said driving transistor to vary the gate potential of said driving transistor in response to the received light amount.

3. The display apparatus according to claim 2, wherein said sampling transistor in the pixel circuit receives light from said light emitting element in the pixel circuit itself.

4. The display apparatus according to claim 2, wherein said sampling transistor in the pixel circuit receives light from the light emitting element in a neighboring pixel circuit.

5. The display apparatus according to claim 2, wherein the light detection line is charged to the potential with which said light emitting element does not emit light.

6. The display apparatus according to claim 2, wherein each of said pixel circuits further includes a holding capacitor connected between the gate and the source of said driving transistor.

7. The display apparatus according to claim 6, wherein, when the light detection operation is carried out by the pixel circuit, said displaying driving section executes a threshold value correction operation of holding a threshold value voltage of said driving transistor into said holding capacitor.

8. The display apparatus according to claim 1, wherein each of said pixel circuits further includes a light detection element connected to a fixed power supply and to the gate of said driving transistor through a second switching transistor; and
as the light detection operation, said light detection element applies, when said second switching transistor is placed in an on state, current in accordance with the received light amount to the gate of said driving transistor thereby to vary the gate potential of said driving transistor in response to the received light amount.

9. The display apparatus according to claim 8, wherein said light detection element is configured from a transistor connected in diode connection.

10. The display apparatus according to claim 8, wherein said light detection element receives light from the outside.

11. The display apparatus according to claim 1, wherein said displaying driving section carries out correction of the signal value in response to the light amount information detected by said light amount information detection section.

12. A light detection method for a display apparatus which includes a plurality of pixel circuits disposed in a matrix at positions at which a signal line and a plurality of scanning lines cross with each other, a displaying driving section adapted to apply a signal value to each of the pixel circuits through the signal line and drive the scanning lines to cause the pixel circuit to carry out light emission with a luminance in accordance with the signal value to carry out image display, and a light amount information detection section adapted to detect light amount information from an output of each of the pixel circuits to a light detection line disposed for the pixel circuit, each of the pixel circuits including alight emitting element, a driving transistor for carrying out application of current to the light emitting element in response to a signal value voltage inputted thereto, a sampling transistor for inputting, when the sampling transistor is switched on, the signal value from the signal line to the gate of the driving transistor, and a switching transistor connected between an end of the driving transistor and the light detection line, the light detection method comprising the step of:
varying, by means of the pixel circuit, the gate potential of the driving transistor in response to the received light amount and outputting the source potential of the driving transistor in response to the potential variation to the light detection line through the switching transistor, and then detecting, by means of the light amount information detection section, light amount information by voltage detection of the light detection line.

13. An electronic apparatus, comprising;
a plurality of pixel circuits disposed in a matrix at positions at which a signal line and a plurality of scanning lines cross with each other;
a displaying driving section adapted to apply a signal value to each of said pixel circuits through the signal line and drive the scanning lines to cause the pixel circuit to carry out light emission with a luminance in accordance with the signal value to carry out image display; and
a light amount information detection section adapted to detect light amount information from an output of each of said pixel circuits to a light detection line disposed for the pixel circuit;
each of said pixel circuits including
a light emitting element,
a driving transistor for carrying out application of current to said light emitting element in response to a signal value voltage inputted thereto,
a sampling transistor for inputting, when said sampling transistor is switched on, the signal value from the signal line to the gate of said driving transistor, and
a switching transistor connected between an end of said driving transistor and the light detection line;
each of said pixel circuits being capable of executing light detection operation of varying the gate potential of said driving transistor in response to a received light amount and outputting the source potential of said driving transistor in accordance with the potential variation to the light detection line through said switching transistor.

14. A display apparatus, comprising:
a plurality of pixel circuits disposed in a matrix;
a signal line; and
a light detection line;
each of said pixel circuits including
a light emitting element,
a driving transistor for carrying out current application to said light emitting element,
a sampling transistor for inputting a signal value from said signal line to the gate of said driving transistor, and
a switching transistor connected between an end of said driving transistor and said light detection line;
the gate potential of said driving transistor being varied in response to a received light amount to output a potential at the one end of the driving transistor to said light detection line through said switching transistor.

15. The display apparatus according to claim 14, wherein the gate potential of said driving transistor is varied in response to the received light amount with leak current generated in said sampling transistor.

16. The display apparatus according to claim 14, further comprising:
a light detection element connected to a fixed power supply;
said light detection element applying current in response to the received light amount to the gate of said driving transistor to vary the gate potential of said driving transistor.

17. The display apparatus according to claim 16, wherein said light detection element is configured from a transistor connected in diode connection.
